(19) United States
(12) Patent Application Publication
(10) Pub. No.: US 2026/0114351 A1
(43) Pub. Date: Apr. 30, 2026

(54) MOUNTING APPARATUS FOR AGRICULTURAL IMPLEMENT

(71) Applicant: HONEY BEE MANUFACTURING LTD., Frontier (CA)

(72) Inventors: Glenn Raymond HONEY, Bracken (CA); Muthanna ABOU NAJM, Frontier (CA); Steve Anthony DUECK, Bracken (CA)

(21) Appl. No.: 18/933,943

(22) Filed: Oct. 31, 2024

(51) Int. Cl. A01B 59/06

(52) U.S. Cl. CPC A01B 59/068

(57) ABSTRACT

An agricultural system which comprises a propulsion unit that comprises at least one, generally longitudinally extending, lift arm. The system also comprises a generally transversely extending implement comprising a generally transversely extending main frame. The implement may be a swather header. A mounting apparatus connects the at least one lift arm to the implement. The mounting apparatus includes a moveable member configured to interconnect the at least one lift arm and the implement and is movable relative to the implement between a first position proximal to the propulsion unit when the propulsion unit is in a mounting ready configuration and a second position distal to the propulsion unit when the propulsion unit is in a mounting ready configuration. The moveable member is lockable in the second position.

### TECHNICAL FIELD

The present disclosure relates, generally, to agricultural implements, including swather headers and, more specifically, to a mounting apparatus for a swather header.

### BACKGROUND

An agricultural implement, such as a swather (or windrower) on a propulsion unit or a spray boom on a power unit, may be propelled across a field. The swather may include a swather header mounted to lift arms of a propulsion or power unit with a mounting assembly. As the swather moves across the field, a cutter bar of the swather header may cut a crop and deposit the crop in windrows for drying.

It is known to connect the agricultural implement to the lift arms of the propulsion unit using at an attachment location on the agricultural implement. The lift arms may provide height adjustment and/or shock absorption of forces imparted to the propulsion unit.

It may be desirable to position the attachment location proximal to the center of gravity of the agricultural implement to ensure that the agricultural implement has acceptable stability. However, this may place attachment location longitudinally forward, which may make it challenging to a user to view the attachment location from the propulsion unit when mounting the agricultural implement to the lift arms of the propulsion unit.

It is therefore desirable to improve upon the design of such agricultural implements.

### SUMMARY

In an aspect of the disclosure, there is provided an agricultural apparatus comprising: a propulsion unit comprising at least one, elongated and generally longitudinally extending, lift arm; a generally transversely extending implement; at least one mounting apparatus operably connected with the implement, the at least one mounting apparatus comprising a moveable member configured to interconnect the at least one lift arm and the implement; wherein the movable member is movable relative to the implement between a first position proximal to the propulsion unit when the propulsion unit is in a mounting ready configuration and a second position distal to the propulsion unit when the propulsion unit is in a mounting ready configuration; and wherein the moveable member is retainable in the second position.

In another aspect of the disclosure, there is provided a mounting apparatus for interconnecting a propulsion unit and an implement, the mounting apparatus comprising: a moveable member configured to interconnect at least one, elongated and generally longitudinally extending lift arm of the propulsion unit and the implement; wherein the movable member is movable relative to the implement between a first position proximal to the propulsion unit when the propulsion unit is in a mounting ready configuration and a second position distal to the propulsion unit when the propulsion unit is in a mounting ready configuration; and wherein the moveable member is retainable in the second position.

In another aspect of the disclosure, there is provided an agricultural implement comprising: at least one mounting apparatus operably connected with the implement comprising a moveable member configured to interconnect the implement and at least one, elongated and generally longitudinally extending, lift arm of a propulsion unit; wherein the movable member is movable relative to the implement between a first position proximal to the propulsion unit when the propulsion unit is in a mounting ready configuration and a second position distal to the propulsion unit when the propulsion unit is in a mounting ready configuration; and wherein the moveable member is retainable in the second position.

### BRIEF DESCRIPTION OF THE DRAWINGS

In figures which illustrate example embodiments:

FIG. 1 is a front perspective view of an agricultural apparatus according to one embodiment;

FIG. 2A is a front side perspective view of the implement of the agricultural apparatus of FIG. 1, with some parts being shown exploded;

FIG. 2B is an opposite rear side perspective view of the agricultural implement of the agricultural apparatus of FIG. 1;

FIGS. 3A, 3B and 3C are perspective views of some frame components of the agricultural implement of FIGS. 1, 2A and 2B;

FIG. 4 is a schematic view of a control system for controlling the implement of the agricultural apparatus of FIG. 1 according to one embodiment;

FIG. 5 is a schematic view of a control system for controlling the implement of the agricultural apparatus of FIG. 1 according to one embodiment;

FIG. 6A is a side view of a portion of the apparatus of FIG. 1;

FIG. 6B is a front side perspective view of a portion of the apparatus of FIG. 6A;

FIG. 6C is a front side perspective view of a portion of FIG. 6B;

FIG. 6D is a front side perspective view of a portion of the apparatus of FIG. 6A, according to another embodiment;

FIG. 7A is a front side perspective view of some components of the implement and propulsion unit of the agricultural apparatus of FIG. 1;

FIG. 7B is an enlarged front side perspective view of some components of the agricultural implement shown in FIG. 7A;

FIG. 7C is a front side perspective view of some components of an agricultural implement according to another embodiment, in a first configuration;

FIG. 7D is a front side perspective view of some components of an agricultural implement according to another embodiment, in a second configuration;

FIG. 8A is an enlarged front perspective view of some other components of the agricultural implement of the agricultural apparatus of FIG. 1;

FIG. 8B is an enlarged rear perspective view of some other components of the agricultural implement of the agricultural apparatus of FIG. 1;

FIG. 8C is an enlarged bottom perspective view of some other components of the agricultural implement of the agricultural apparatus of FIG. 1;

FIG. 8D is a front perspective view of the components shown in FIG. 8C, with some components removed;

FIG. 8E is an enlarged front perspective view of the components shown in FIG. 8D, with some components exploded;

FIG. 8F is a front perspective view of the components shown in FIG. 8D, with some components removed;

FIG. 9A is an enlarged front perspective view of some other components of the agricultural implement of the agricultural apparatus of FIG. 1;

FIG. 9B is a bottom perspective view the components of FIG. 9A;

FIG. 9C is a left-side perspective view of the components shown in FIG. 9A, with some components removed;

FIG. 9D is right-side perspective view of the components shown in FIG. 9A, with some components removed;

FIG. 10A is a right-side perspective view of a component of the agricultural implement of FIG. 1, in a first configuration;

FIG. 10B is a right-side perspective view of a component of the agricultural implement of FIG. 1, in a first configuration;

FIG. 10C is a left-side perspective view of the component of FIG. 10A;

FIG. 11A is a side view of the agricultural apparatus of FIG. 1, prior to connection of the agricultural implement and the propulsion unit;

FIG. 11B is a side view of the apparatus of FIG. 1, during connection of the agricultural implement and the propulsion unit, partially connected;

FIG. 11C is a side view of the apparatus of FIG. 1, after connection of the agricultural implement and the propulsion unit;

FIG. 12 is a perspective view of a three-point hitch that may form part of a propulsion unit, and which may be utilized to support a swather header.

### DETAILED DESCRIPTION

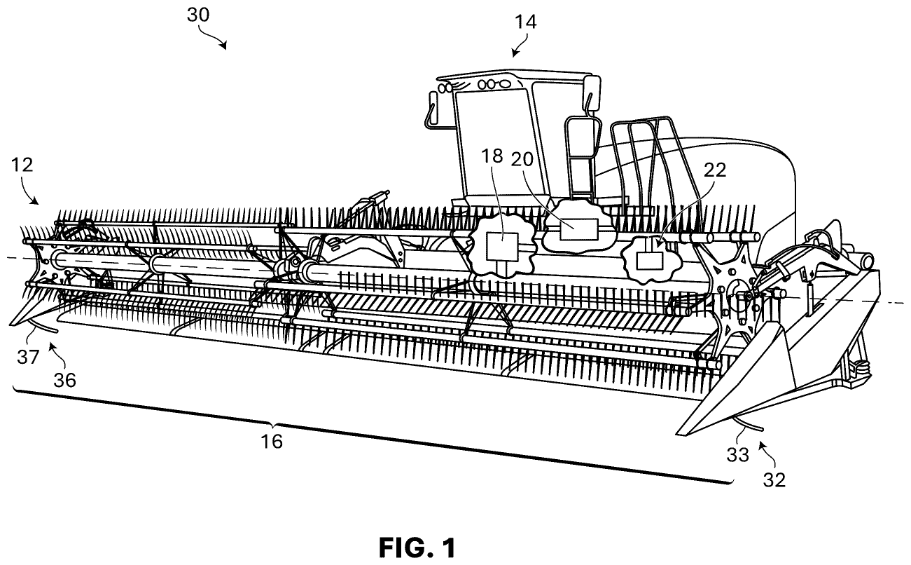

Referring to FIG. 1, an agricultural apparatus in accordance with one embodiment is shown at 30. Agricultural apparatus 30 may include an agricultural implement operably connected to a propulsion unit 14. The agricultural implement may include a mounting end at a rear end of the agricultural implement (generally located proximal to the propulsion unit) and a working end at a front end of the agricultural implement (generally located distal to the propulsion unit). Agricultural apparatus 30 may for example be a swather or windrower including an agricultural implement such as swather header 12 which may be mounted to and supported at least in part by propulsion unit 14.

Propulsion unit 14, may be a known type of tractor, which may be configured and adapted to provide support for swather header 12 in front of propulsion unit 14 with the swather header 12 oriented in a forward-facing direction (as shown in FIG. 1). Propulsion unit 14 is operable to propel the forward movement of swather header 12 to cut and process crop material, and propulsion unit 14 can provide power and other utilities to swather header 12, during operation. In some embodiments, a swather header 12 may be supported in a rearward location of a propulsion unit, such that the swather header is oriented in a rearward facing direction relative to the propulsion unit. In such embodiments, the propulsion unit is operable to move rearwardly with the rearwardly facing header 12 and swather header 12 is operable to cut and process crop material during such rearward direction of the propulsion unit. Swather header 12 may be configured to cut crop material from crops growing in a field while the apparatus 30 is driven across a crop field by propulsion unit 14. Swather header 12 may also form the cut crop material into a windrow for drying and/or ripening. The crop material may then be subsequently collected, for example, baled, combined or rolled.

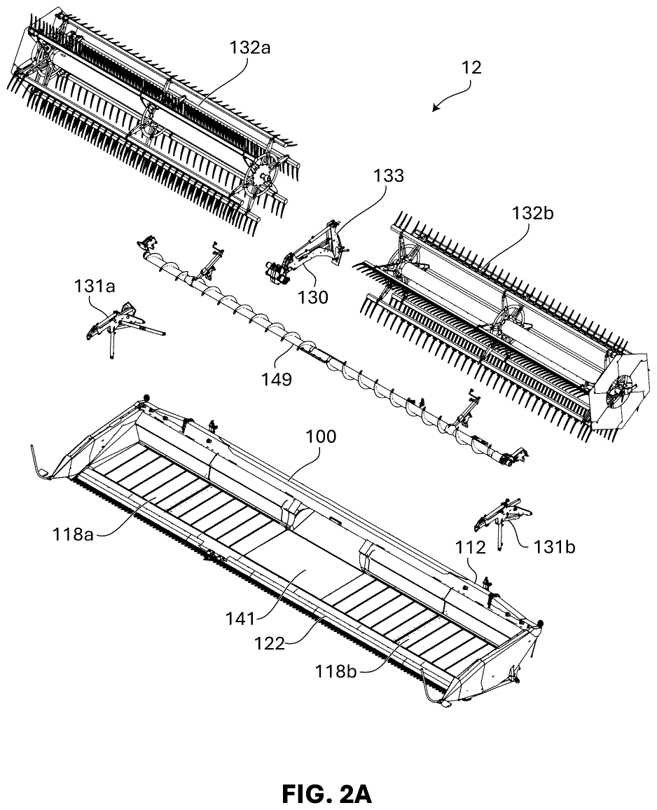

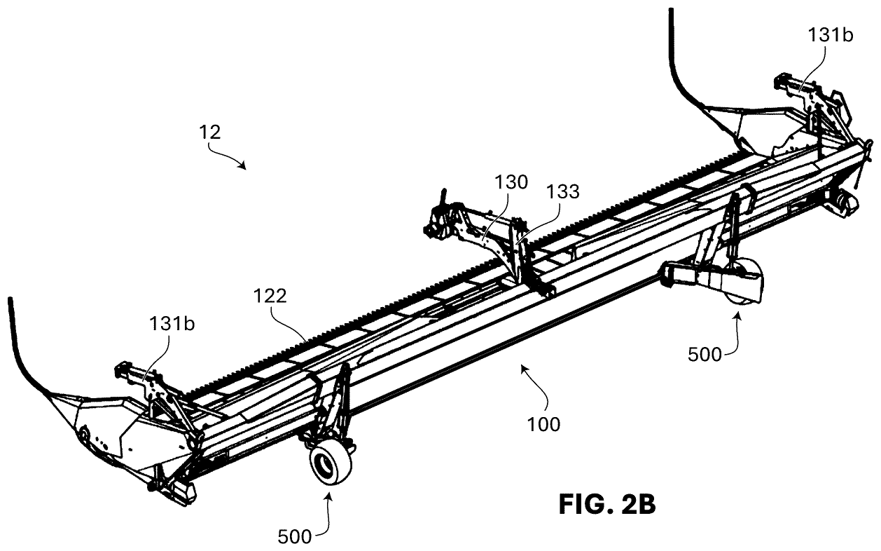

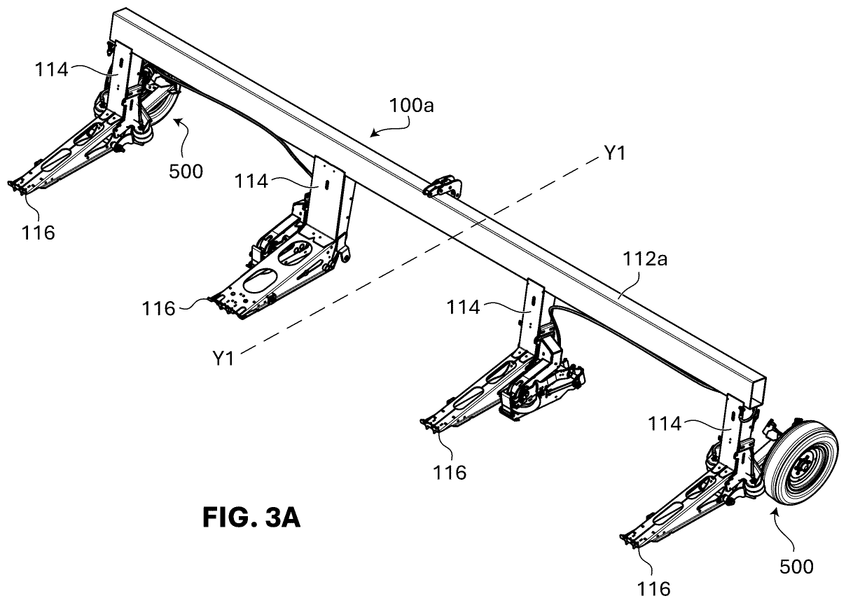

With particular reference to FIGS. 2A and 2B, swather header 12 extends generally transversely and may include a generally transversely extending main header frame generally designated 100. As shown in FIGS. 3A to 3C, main header frame 100 may include a main transverse support beam 112 (see FIG. 2A), which may include a central support beam component 112a, a right-side extension support beam component 112b and a left-side extension support beam component 112c. Support beam components 112a, 112b, 112c, may be fixedly connected to each other (for example, with bolted flanges) in an end-to-end relation with longitudinal alignment to create a transversely extending composite continuous transverse support beam 112. Transverse support beam 112 may be made from any suitably strong and configured material, such as a steel (such as ASTM A36 steel) hollow sectional tube member. Main header frame 100 may include a plurality of transversely spaced, generally downwardly depending, vertical struts 114, fixedly secured to transverse support beam 112, such as, for example, with fasteners or by welding. Swather header 12 may have a weight which includes the weight of the main header frame 100, and the weight of the other components of the swather header that are mounted to/supported by the main header frame 100. By way of example only, swather headers in the range of 15 ft to 65 ft wide may have a corresponding range in total weight from about 1500 lbs. to about 8000 lbs. It may be noted that the weight of a header for a swather apparatus may be significantly less than the weight of a header for a corresponding width combine apparatus due to the former typically having fewer relatively heavy components, e.g. may be in order of about 3500 lbs. less in weight for the same width headers.

Main header frame 100 may also include a plurality of generally forwardly extending horizontal struts 116, each fixedly secured, such as, for example, with fasteners or by welding, to a bottom end region of each vertical strut 114. Each vertical strut 114 may be made from any suitably strong and configured material, such as a steel (such as ASTM A36 steel) hollow sectional tube member. Each horizontal strut 116 may be a steel structural open member, such as a structural open member made from ASTM A36 steel.

Main header frame 100 may thus be formed as a central frame section 100a (FIGS. 3A to 3C) with opposite side frame sections 100b and 100c. For each frame section, 100a, 100b, 100c, the main support beams and vertical and horizontal struts may be fastened or welded together to form a single assembly/weldment. The center, right and left frame sections 100a, 100b, 100c can then be bolted together. Depending upon the required overall transverse width, the right and left frame section may vary in width, such that swather headers may range in total width of between about 15 ft and 60 ft, or possibly more.

With reference to FIGS. 1, 2A and 2B, swather header 12 may also include first and second lateral, transversely extending draper decks 118a, 118b supported on main header frame 100 and located on opposite transverse ends of swather header 12. Draper decks 118a, 118b may be mounted to main header frame 100 in a known manner and may be operable to collect and feed cut crop material to a swath opening 141 located between the inner ends of draper decks 118a, 118b. The crop material will fall through swath opening 141 and be deposited onto the ground surface in a windrow.

In other embodiments, swather header 12 may have more than one swath opening for depositing the cut crop onto the ground surface in more than one windrows at a time. Crop may be fed to each of the swath openings through a suitable arrangement of additional draper decks.

Swather header 12 may also include a center reel arm 130, a right-side reel arm 131a and a left side reel arm 131b, which may be mounted to, and supported by, main header frame 100 in a known manner. Center reel arm 130 and right-side reel arm 131a may support, for rotation about a reel axis, a right reel section 132a. Center reel arm 130 and left-side reel arm 131b may support, for rotation about the same common transversely extending reel axis, a left reel section 132b. Right and left reel sections 132a, 132b may be driven about their common transversely oriented reel axis with known reel drive systems. Reel sections 132a, 132b may be operable to pull crop material onto cutter bar 122 to be cut by the cutting blades of cutter bar 122, and then pull cut crop material directly into swath opening 141 and also onto draper decks 118a, 118b for transport to swath opening 141. In some embodiments, swather header 12 may not include a center reel arm 133 and may only have a right-side reel arm 131a and a left-side reel arm 131b.

Swather header 12 may also be equipped with at least one stabilizer apparatus generally designated 500 (and possibly two or more) on each lateral side of the center line, Y1-Y1, of swather header 12 (FIG. 3A). Stabilizer apparatus(es) 500 on each side can assist in carrying some of the forces acting on swather header 12, during various modes of operation.

### Lift Arms

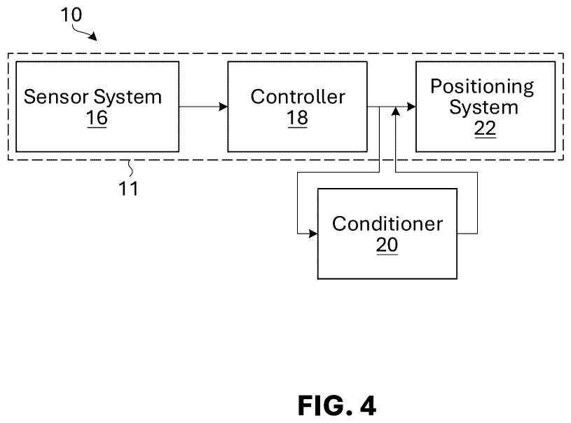

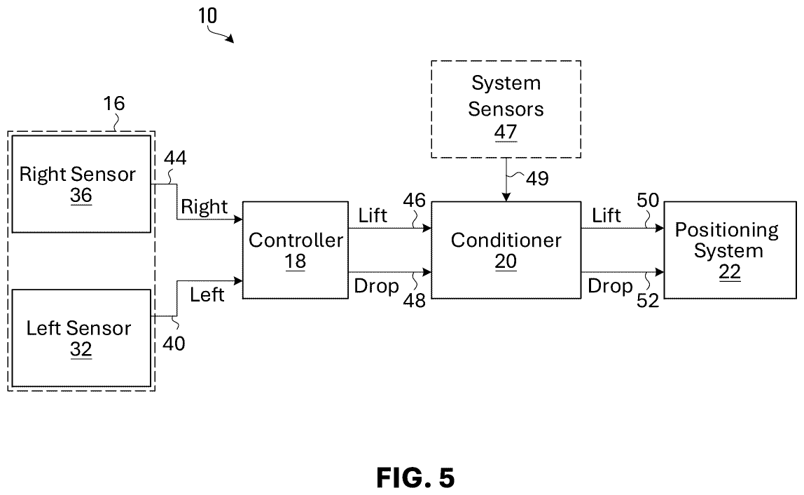

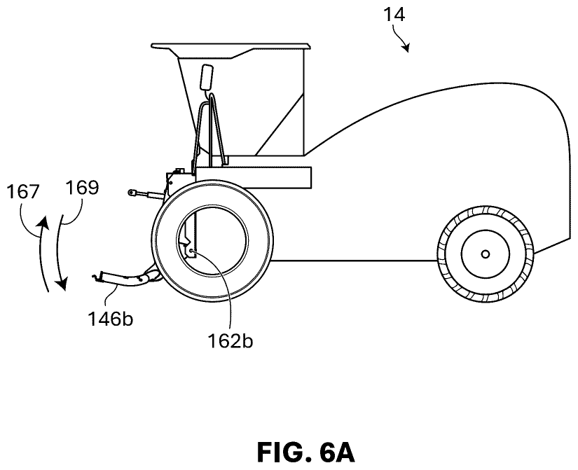

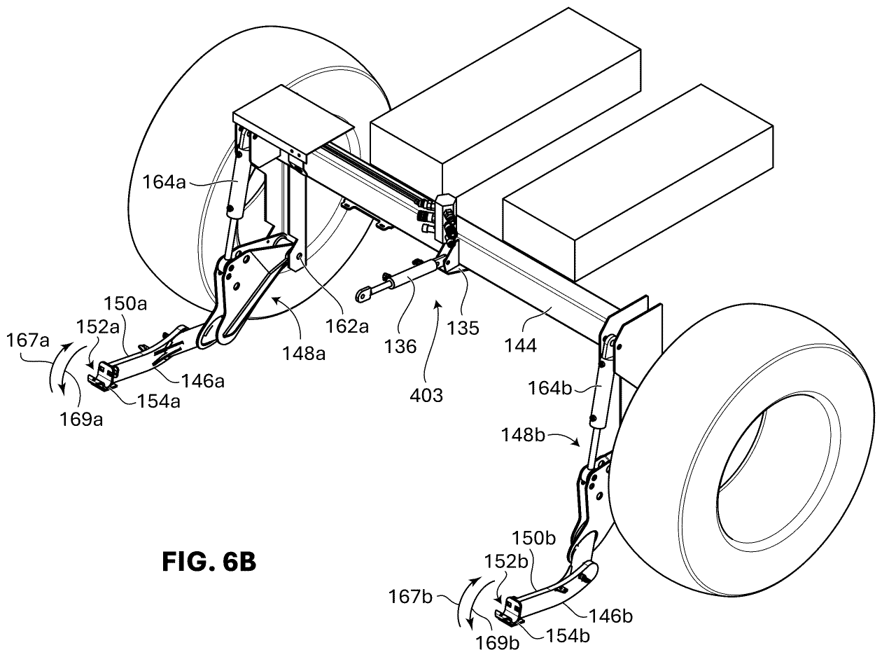

With particular reference to FIGS. 6A, 6B, at the front/forward end or side of propulsion unit 14 may be a structural member such as a transverse beam member 144, which may generally form a front part of the swather chassis to which a pair of generally forwardly longitudinally extending, elongated lift arms 146a, 146b may be pivotally connected via respective pivotal connections 148a, 148b. Lift arms 146a, 146b may generally extend at least partially beneath, and may provide support to, swather header 12. Lift arms 146a, 146b may carry/support at least a portion, and possibly substantially all, of the weight of swather header 12, including a portion or substantially all of the weight of main header frame 100.

Pivotal connections 148a, 148b may be any suitable type of connection to facilitate generally upwards and downwards motion of lift arms 146a, 146b (and in particular at least distal forward end portions 152a, 152b located at or proximate respective distal end regions of lift arms 146a, 146b) about respective pivot points 162a, 162b, as will be explained in more detail below. Depending on the type/brand/model of propulsion unit 14 being utilized, the arrangement of pivotal connections 148a, 148b, lift arms 146a, 146b and their attachment to propulsion unit 14 may vary.

In some embodiments, lift arms 146a, 146b may be mechanically coupled together such that lift arms 146a, 146b may move generally upwards/downwards in unison.

With reference to FIG. 6C, lift arm 146a (like lift arm 146b) may include a generally rectangular (in cross section), forwardly longitudinally extending member 150a terminating at a lower distal end region/portion 152a, which may be formed as a generally J-shaped open bracket defining a moveable member receiving channel 154a.

Similarly, lift arm 146b may include a generally rectangular and forwardly longitudinally extending end member 150b terminating at a lower distal end region/portion 152b, which may be formed as a generally U-shaped open bracket defining a moveable member receiving channel 154b (FIG. 6B).

As will be explained in more detail below, lower distal end portions 152a, 152b, which may have any suitable shape and configuration, may interconnect with swather header 12 and lower end portions 152a, 152b may act as/provide a lift point/location for raising and/or lowering swather header 12.

As will be described further hereinafter, the connection between propulsion unit 14 and main header frame 100 may be a “three-point” pivotal connection that enables the propulsion unit 14 to support all, most or some of the weight of the swather header 12, it may also permit a limited degree of lateral (side-to-side) tilting in upward and downward lateral directions of main header frame 100 relative to propulsion unit 14, about an upper pivotal connection and, thus, relative to lift arms 146a, 146b.

### Header Height Control

As may be evident from the foregoing, swather header 12 may, in some modes of operation be able to efficiently cut the crop material when main header frame 100 of swather header 12 is kept at a constant height or separation distance close to but generally above the ground, without striking the ground. As agricultural apparatus 30 travels over the ground, the ground may have inconsistencies and undulations and, therefore, in order to keep swather header 12 at a constant height relative to the ground, agricultural apparatus 30 may have a sensor system 16 to sense changes in level of the ground, which may act as a reference surface. Agricultural apparatus 30 may then control a position of main header frame 100 of swather header 12 relative to propulsion unit 14 to maintain main header frame 100 of swather header 12 at a constant or desired height above the reference surface.

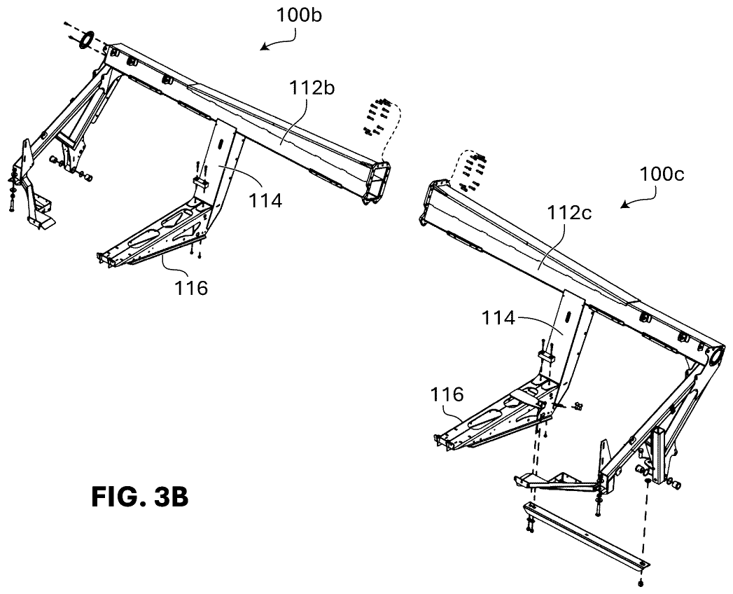

Referring to FIG. 4, to control the position of swather header 12, agricultural apparatus 30, as shown in FIG. 1, may include header height control system 10 for controlling the movement/position of swather header 12 relative to propulsion unit 14. Header height control system 10 may include a controller system 11 including a sensor system 16, a header height controller 18, and a header positioning system 22. Controller system 11 may be a known controller system, such as supplied by a manufacturer of the apparatus for controlling movement of the agricultural implement.

Referring to FIG. 1, sensor system 16 may be configured to sense a position of swather header 12 (e.g., of main header frame 100 relative to the ground) and to transmit position signals representing the sensed position to header height controller 18. Header height controller 18 may receive the position signals representing the sensed position and compare the sensed position to a desired position to determine a difference. Header height controller 18 may then produce control signals, based on the difference. Header height controller 18 may be configured to transmit the control signals to header positioning system 22, which may control hydraulic actuators, for example, to cause movement of main header frame 100 of swather header 12 towards a desired position relative to propulsion unit 14. While the embodiments herein are described with reference to hydraulic actuators, in some embodiments, other types of actuators, such as electrical actuators, may be employed to cause movement of main header frame 100 of swather header 12.

Header positioning system 22 may have a positioning response time for causing agricultural apparatus 30 to respond to the control signals. In cases where header positioning system 22 has a positioning response time that results in excessive movement or “hunting” for the desired position, according to the teachings herein, header height control system 10 may be provided with a signal conditioner 20, which is configured to condition the control signals transmitted by header height controller 18 and normally received by header positioning system 22. Signal conditioner 20 may be configured to intercept the control signals transmitted by header height controller 18, to generate conditioned control signals and to transmit the conditioned control signals or output signals to header positioning system 22 instead of the control signals, in response to the control signals transmitted by header height controller 18. Signal conditioner 20 may be configured to receive system sensor signals 49 from an optional plurality of system sensors 47. The generating of the conditioned control signals may, at least in part, be based on system sensor signals 49.

Referring back to FIG. 1, header height control system 10 of FIG. 4 may be mounted on agricultural apparatus 30. In the embodiment shown, sensor system 16 may include left sensors 32 and right sensors 36 located at first and second locations on left and right ends respectively of main header frame 100 of swather header 12.

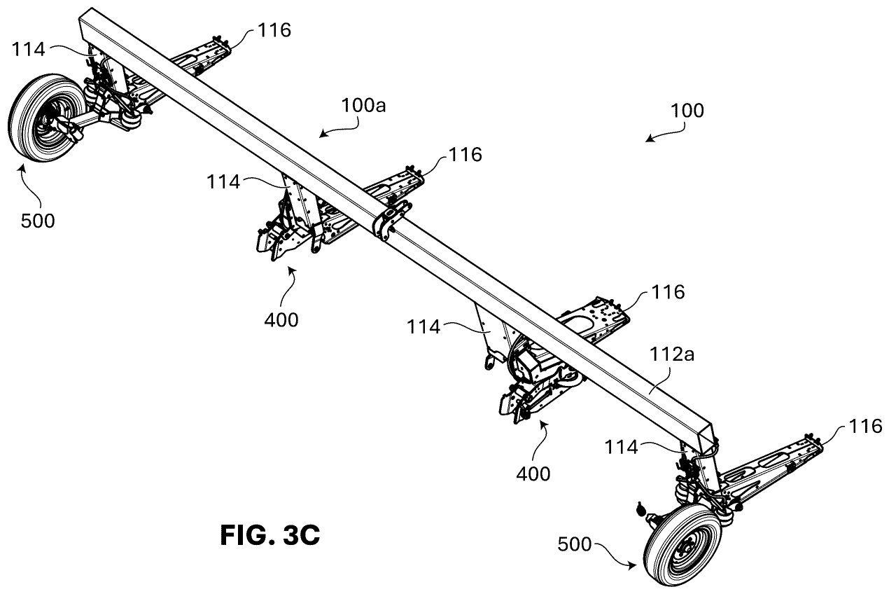

Referring to FIGS. 1 and 5, sensors 32 and 36 may be configured to send left and right position signals 40 and 44 representing left and right sensed positions or heights of respective locations, on swather header 12 (in particular on main header frame 100) relative to the ground, to header height controller 18. In some embodiments, sensors 32 and 36 may each include a sensing arm or paddle attached to main header frame 100 (shown at 33 and 37 in FIG. 1) and a Hall Effect sensor configured to sense a rotational angle of the sensing arm.

In various embodiments left and right position signals 40 and 44 may be electrical signals that have a voltage level representing a sensed position or height measured by their respective sensor. For example, the voltage level of left and right position signals 40 and 44 may be between a low voltage level and a high voltage level, with a low voltage level representing 0% of a maximum sensed height and high voltage level representing 100% of the maximum sensed height. For example, in some embodiments, the low voltage level may be about 1 Volt and the high voltage level may be about 4 Volts. However, in various other embodiments, the high and low voltage levels of left and right position signals 40 and 44 may be other voltage levels.

In the embodiment shown, sensors 32 and 36 have a minimum sensed height of about 0 inches and a maximum sensed height of about 18 inches. However, in various embodiments, sensors 32 and 36 may sense other ranges of heights.

In various embodiments, sensors 32 and 36 may transmit left and right position signals 40 and 44 to header height controller 18 using electrical wires, for example, coupled to a respective one of sensors 32 and 36 at one end and to header height controller 18 at another end.

Referring still to FIG. 5, in various embodiments, header height controller 18 may be configured to receive or sample left and right position signals 40 and 44 representing the left and right sensed heights of main header frame 100 of swather header 12. In some embodiments, header height controller 18 may be configured to sample the position signals periodically, such as once every about 20 ms, for example. Header height controller 18 may be configured to compare each of the left and right sensed heights with desired left and right heights respectively to determine differences between the sensed heights and the desired heights. In some embodiments, header height controller 18 may be configured to receive signals representing the desired left and right heights from memory and/or via an I/O interface of header height controller 18, for example. The desired heights may be about 2″, for example.

Header height controller 18 may, based on the differences between the sensed heights and the desired heights, produce lift control signals 46 and drop control signals 48 for causing header positioning system 22 to move main header frame 100 of swather header 12 towards the desired heights.

For example, in some embodiments, header height controller 18 may be configured to determine a left difference between the left sensed height and the left desired height and to determine a right difference between the right sensed height and the right desired height. When at least one of the left and right differences represents a sensed height that is less than a desired height and has an absolute value that is greater than a threshold difference, header height controller 18 may produce lift and drop control signals 46 and 48 such that, if the control signals were transmitted to header positioning system 22, the control signals would cause header positioning system 22 to cause main header frame 100 of swather header 12 to be raised relative to propulsion unit 14 shown in FIG. 1.

If only one of the left and right differences represents a sensed height that is less than a desired height and has an absolute value that is greater than a threshold difference, header height controller 18 may produce lift and drop control signals 46 and 48 such that there will be both a suitable height adjustment of main header frame 100 relative to the ground surface and a lateral tilt adjustment carried out by header positioning system 22 to achieve a desired frame height on both the right and left sides.

If neither of the left and right differences represents a sensed height that is less than a desired height and has an absolute value that is greater than the threshold difference and at least one of the left and right differences represents a sensed height that is greater than a desired height and has an absolute value that is greater than a threshold difference, header height controller 18 may produce lift and drop control signals 46 and 48 such that, if the control signals were transmitted to header positioning system 22, the control signals would cause header positioning system 22 to drop (i.e., lower) main header frame 100 of swather header 12 relative to propulsion unit 14 shown in FIG. 1. If the left and right differences are both within a threshold range, header height controller 18 may produce lift and drop control signals 46 and 48 to cause header positioning system 22 to not change the height of main header frame 100 of swather header 12 relative to propulsion unit 14 shown in FIG. 1.

As discussed above, header height controller 18 may be configurable to transmit lift and drop control signals 46 and 48 directly to header positioning system 22 but, in the embodiment shown in FIG. 5, conditioner 20 may optionally be provided. Conditioner 20 may be configured to intercept lift and drop control signals 46 and 48 produced by header height controller 18 and to produce and transmit conditioned lift control or output signals 50 and conditioned drop control or output signals 52 to header positioning system 22 instead of the control signals. An example of the incorporation of a conditioner 20 into the control system is disclosed in U.S. Pat. No. 10,462,966, issued on Nov. 5, 2019, the entire contents of which is hereby incorporated by reference herein.

FIG. 6A shows a side view of propulsion unit 14 without swather header 12 attached, showing elements of header positioning system 22 (see FIG. 4), in accordance with one embodiment. Referring to FIGS. 6A and 6B, header positioning system 22 includes lift arms 146a, 146b, which may be pivotally connected to propulsion unit 14 at pivot points 162a, 162b via respective pivotal connections 148a, 148b. In the embodiment shown in FIGS. 6A and 6B, pivotal connections 148a, 148b are associated with a height and tilt controlling hydraulic system, including hydraulic cylinders 164a, 164b. Hydraulic cylinder 164a is connected, at one end, to the right end region of transverse beam member 144 of propulsion unit 14 and, at the other end, to lift arm 146a. Similarly, hydraulic cylinder 164b is connected, at one end, to the left end region of transverse beam member 144 of propulsion unit 14 and, at the other end, to lift arm 146b.

The height and tilt controlling hydraulic system may include a “lift” valve, such as, for example, a solenoid-controlled valve, which may be controlled using conditioned lift output signal 50 and a “drop” valve, such as, for example, a solenoid-controlled valve, which may be controlled using conditioned drop output signal 52. When the lift valve is opened and the drop valve is closed, hydraulic cylinders 164a, 164b both retract. Conversely, when the lift valve is closed and the drop valve is opened, hydraulic cylinders 164a, 164b both extend.

In various embodiments, each time header positioning system 22 is instructed by header height controller 18 to move, there may be a positioning response time before header positioning system 22 finishes moving and reaches a generally non-transient or fixed position. In various embodiments, the positioning response time may be due to a variety of factors, such as, for example, weight and momentum of swather header 12, time required for valves of height and tilt controlling hydraulic system to open and/or close after being commanded to do so, and/or float in the height and tilt controlling hydraulic system.

### Lateral Tilt

The height and tilt controlling hydraulic system (header positioning system 22) may also allow for tilting of main header frame 100 relative to propulsion unit 14. Swather header 12 may, thus, be laterally tilted relative to propulsion unit 14 when there is a difference in the side to side slope of the ground surface beneath swather header 12, compared to the side to side slope of the ground surface beneath propulsion unit 14 and the corresponding slope of propulsion unit 14, itself. In some embodiments, this tilting may be achieved by different amounts of extension/retraction of hydraulic cylinders 164a, 164b, which extension/retraction may be shown to cause swather header 12 to tilt transversely about a forwardly directed rotational axis.

In some embodiments, header height controller 18 may be configured to produce tilt control signals in addition to the signals already described, based on the received left and right position signals 40 and 44. The tilt control signals may be configured to control a lateral tilt of main header frame 100 of swather header 12.

The tilt control signal may cause extension of hydraulic cylinder 164a, causing the front portion of lift arm 146a (and, thus, a right side of main header frame 100 of swather header 12) to move downwards in the direction of arrow 169a (FIG. 6B). Conversely, retraction of hydraulic cylinder 164a causes the front portion of lift arm 146a (and, thus, a right side of main header frame 100 of swather header 12) to move upwards in the direction of arrow 167a.

Similarly, the tilt control signal may cause extension of hydraulic cylinder 164b, causing the front portion of lift arm 146b (and, thus, a left side of main header frame 100 of swather header 12) to move downwards in the direction of arrow 169b (FIG. 6B). Conversely, retraction of hydraulic cylinder 164b causes the front portion of lift arm 146a (and, thus, a left side of main header frame 100 of swather header 12) to move upwards in the direction of arrow 167b. In some embodiments, the tilt control signal may cause simultaneous extension of hydraulic cylinder 164a, coupled with retraction of hydraulic cylinder 164b, or simultaneous retraction of hydraulic cylinder 164a, coupled with extension of hydraulic cylinder 164b, thereby causing lateral tilt of swather header 12 relative to propulsion unit 14.

In some embodiments, header height controller 18 may be configured to cause the tilt control signals to direct header positioning system 22 to tilt main header frame 100 of swather header 12 together, such that the heights sensed by left and right sensors 32 and 36 are equal. In some embodiments, header height controller 18 may be configured to transmit the tilt control signals directly to header positioning system 22. In some embodiments, header height controller 18 may transmit the tilt control signals to conditioner 20, and conditioner 20 may relay the tilt control signals to header positioning system 22. In some embodiments, conditioner 20 may condition the tilt control signals generally as described above having regard to lift and drop control signals 46 and 48 shown in FIG. 5.

In other embodiments, propulsion unit 14 may be configured such that hydraulic cylinders 164a, 164b only operate in unison, such that hydraulic cylinders 164a, 164b will both move upwards/downwards at the same time and approximately the same distance. In such embodiments, lift arms 146a, 146b do not provide any lateral tilt of swather header 12 and lateral tilt of swather header 12 is only provided by the three-point pivotal connection described herein.

As described above, in some embodiments, lift arms 146a, 146b may be mechanically coupled together such that lift arms 146a, 146b may move upwards and downwards in unison, such that such that hydraulic cylinders 164a, 164b are only operated in unison. In other embodiments where lift arms 146a, 146b may be mechanically coupled together, hydraulic cylinders 164a, 164b may be replaced by a single hydraulic cylinder that causes upwards/downwards movement of both lift arms 146a, 146b. In some embodiments, lift arms 146a, 146b may be interconnected by a transversely extending member (such as a cylindrical tube) that is interconnected to a hydraulic cylinder. Actuation of the hydraulic cylinder may cause rotation of the transversely extending member about a rotation axis of the member, causing the interconnected lift arms 146a, 146b to also raise or lower.

In some embodiments, propulsion unit 14 may be configured such that upwards movement of lift arms 146a, 146b may be affected without controlled retraction of hydraulic cylinders 164a, 164b, but is instead affected by a hydraulic accumulator float and/or a mechanical float (such as a mechanical slotted linkage float). In some embodiments, the hydraulic accumulator float and/or the mechanical slotted linkage float (also known as a dead lift float) allows of lift arms 146a, 146b to “float” about 6 inches upwards within the range of the linkage. The mechanical float may be unaided, or may be aided by a mechanism, such as a hydraulic cylinder.

### Connection/Mounting Apparatuses

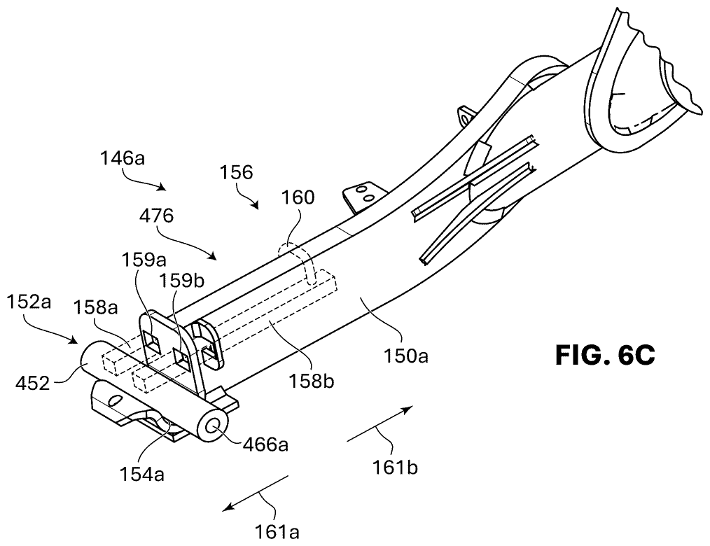

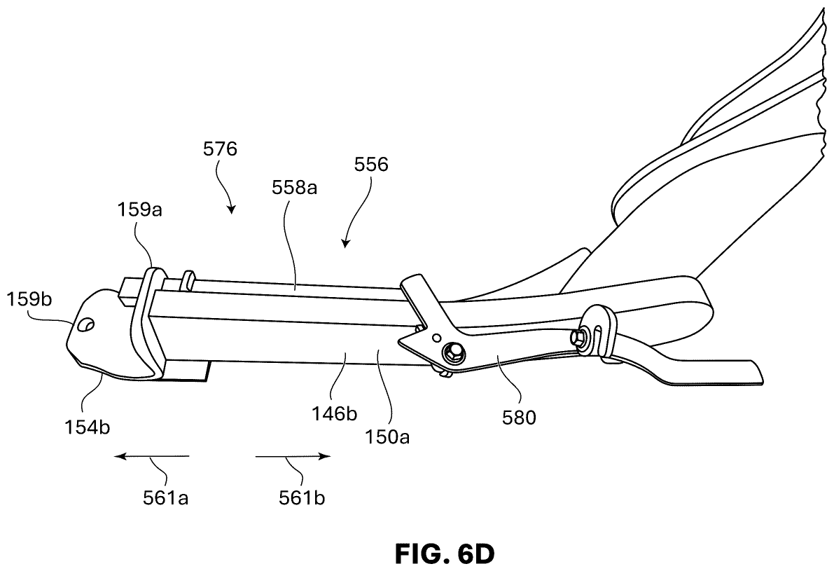

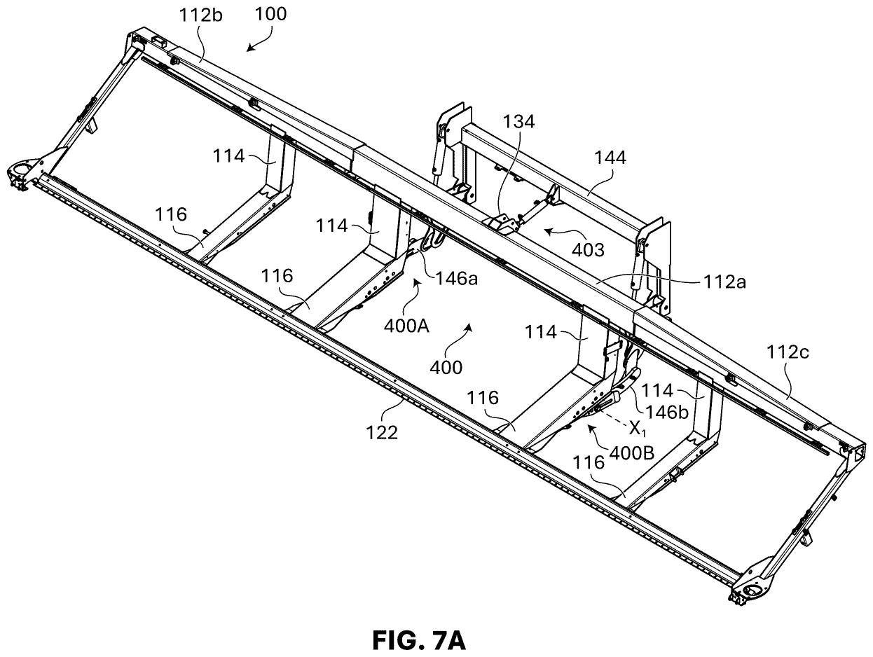

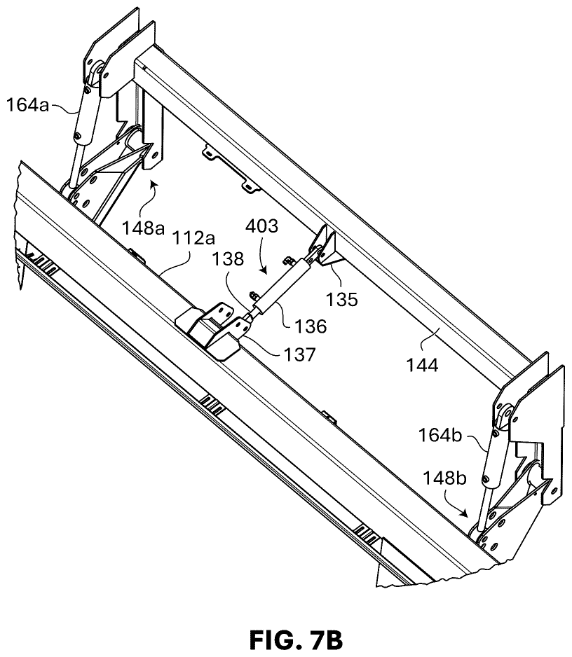

As will be explained in more detail below, swather header 12 shown in FIG. 1 is mounted to lift arms 146a, 146b of propulsion unit 14 shown in FIGS. 6A and 6B, via one more connection/mounting apparatuses generally designated 400 (FIG. 7A) that may be operably located, and provide connection, between lift arms 146a, 146b and main header frame 100. Extension of hydraulic cylinders 164a, 164b causes the front portions of lift arms 146a, 146b (and, thus, main header frame 100 of swather header 12 shown in FIG. 1 when attached to lift arms 146a, 146b) to move downward relative to propulsion unit 14 in the direction of arrow 166. Conversely, retraction of hydraulic cylinders 164a, 164b may cause the front portions of lift arms 146a, 146b (and, thus, main header frame 100 of swather header 12 shown in FIG. 1 when attached to the front portions of lift arms 146a, 146b) to move upwards relative to propulsion unit 14 in the direction of arrow 167.

Still referring to FIG. 7A, agricultural apparatus 30 may include a right-side mounting apparatus 400A and a left-side mounting apparatus 400B, with mounting apparatus 400A being transversely spaced from mounting apparatus 400B, and with each being equally spaced from a centre line of main frame 100, that is aligned with an upper connecting apparatus 403.

Mounting apparatuses 400A and 400B may form part of a header suspension system, which may provide for shock absorption between swather header 12 (such as between main header frame 100 of swather header 12) and lift arms 146a, 146b of propulsion unit 14. The header suspension system may be any suitable suspension system such as a physical spring suspension system or a fluid suspension system. In some embodiments the header suspension system includes an assembly that includes one or more pressurized expandable, flexible gas (e.g. air) bags which are capable of transmitting loads from one side of the bag to another, with the bags being positioned between members that are movable relative to each other.

In some embodiments, the header suspension system may include one or more stabilizer apparatuses (such as stabilizer apparatus(es) 500 described above), each operable to support a portion of the weight of swather header 12 and each having one or more pressurized expandable, flexible gas (e.g. air) bags which are capable of transmitting loads from one side of the bag to another, with the bags being positioned between members that are movable relative to each other.

Pressurized gas/air bags are particularly useful in that they may have a substantially constant spring rate through the desired range of travel/movement of the bag surfaces and the members that are in contact with such surface. The design of the header suspension assembly may be such that the motion of the members engaged by the bag surfaces operates through the constant spring rate zone of the expandable bag.

However, the header suspension system in other embodiments may include an assembly that incorporates other spring type devices, such as coil springs, leaf springs, hydraulic springs, cylindrical helix springs, conical helix springs, disc springs, tension springs, turn springs, spiral springs, tape springs, magnetic springs, torsion springs, or rubber springs. Indeed, the header suspension system may possibly be configured with an assembly may incorporate as a spring device any elastic material or design that has a spring rate.

Upper connecting apparatus 403 is depicted in greater detail in FIG. 7B. A propulsion unit mounting bracket 135 may be formed on an upward facing surface of a transverse beam member 144 of propulsion unit 14. Propulsion unit mounting bracket 135 may be pivotally connected to a rear end of a hydraulic cylinder 136. The forward end of hydraulic cylinder 136 may be connected to a bracket 137 with a spherical bearing mounting 138 that accommodates tilting of main header frame 100. Bracket 137 is, in turn, connected to transverse support beam 112a of main header frame 100. Whilst not shown in FIGS. 7A and 7B, in embodiments where swather header 12 includes a center reel arm tower 133 with a center reel arm 130, the reel arm 130 can be used for supporting inward ends of respective reel sections. Reel arm tower 133 may be mounted to a suitable structural member of header 12 such as main frame member 112a via bracket 137, thereby connecting center reel arm tower 133 to transverse support beam 112a of header 12.

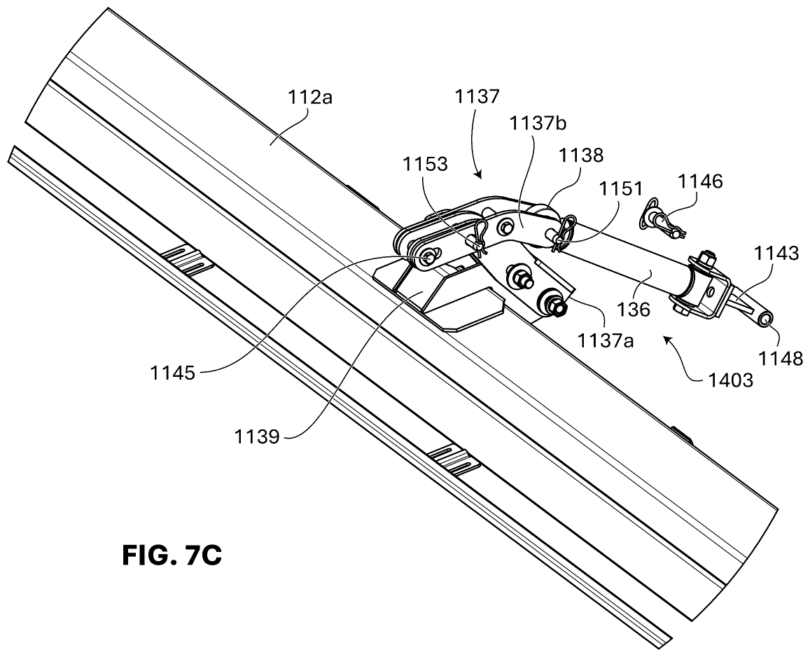

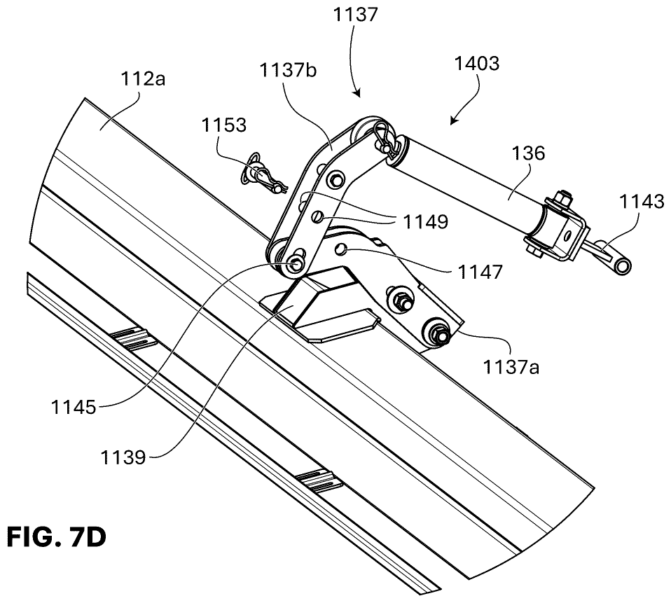

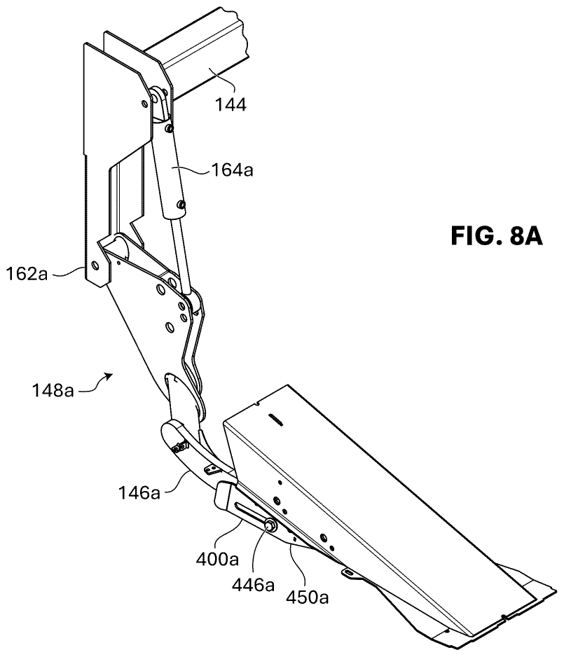

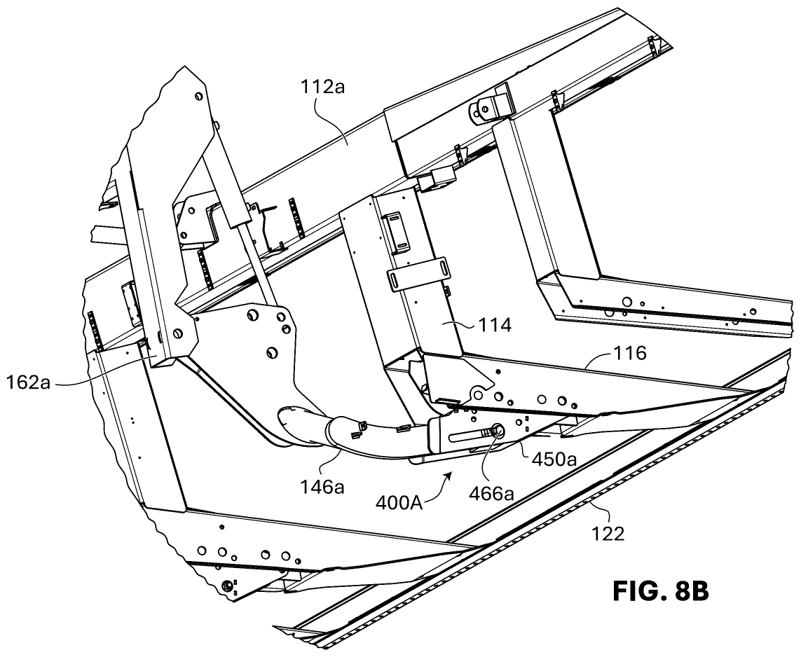

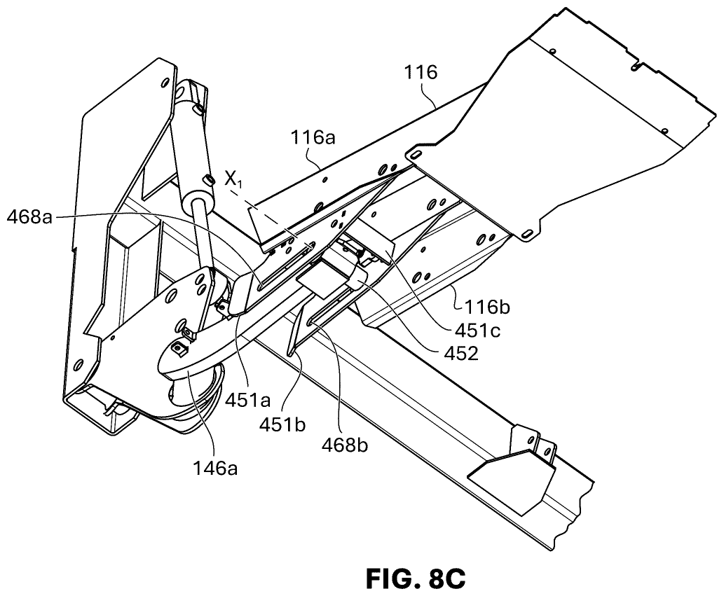

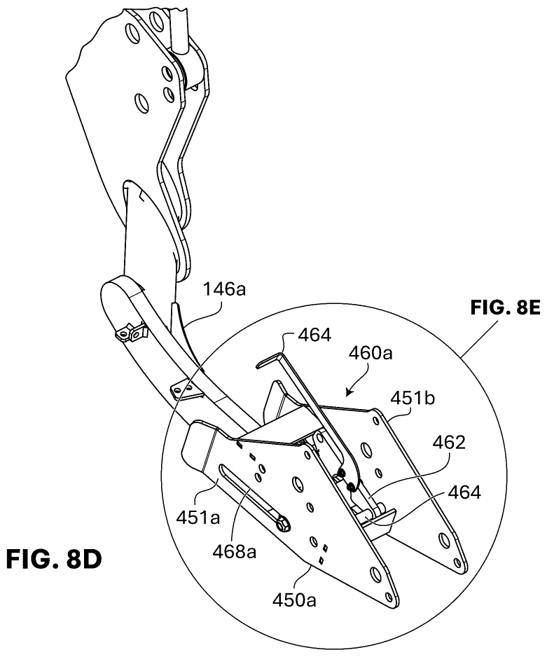

Hydraulic cylinder 136 may be double/two-way acting and may be fluidly connected to a header hydraulic fluid system which may constitute part of, and/or be fluidly interconnected to the hydraulic fluid system of propulsion unit 14, such that the extension / retraction of hydraulic cylinder 136 may be operated and controlled. Hydraulic cylinder 136 may be configured and operable to be able to enable main header frame 100 to be tilted forwards/backward (fore/aft) relative to transverse beam member 144 (and interconnected propulsion unit 14). Main header frame 100 including vertical struts 114 that are interconnected to mounting apparatuses 400A, 400B, may pivot forward and backwards about transverse axis X1 (FIGS. 7A and 8C) on opposed laterally spaced moveable members 466a, 466b (which each are pivotably movable within a bushing 452)—as will be explained in more detail below, when hydraulic cylinder 136 is operated (such as by an operator or controller). This enables header 12 to have the forward/backward angle of the cutting knives on cutter bar 122 relative to the ground surface adjusted. It may be desirable to adjust the fore/aft angle of the cutting knives dependent, for example, on the header height and on what type of crop is being harvested in a particular situation.

In other embodiments, hydraulic cylinder 136 may be connected to another part of propulsion unit 14, such that operation of hydraulic cylinder 136 still affects forwards/backwards tilting of main header frame 100 relative to propulsion unit 14.

With reference to FIGS. 7C and 7D, another embodiment of the upper connecting apparatus/pivotal connection 403, upper pivotal connection 1403 is depicted, which provides an interconnection between transverse beam member 144 of propulsion unit 14 and transverse support beam 112a of main header frame 100. In this embodiment, the rear end of hydraulic cylinder 136 may be pivotally connected to propulsion unit mounting bracket 135 (not shown in FIGS. 7C and 7D but shown in FIG. 7B) at pivotal connection 1143 by a pin 1146 (not shown in FIGS) which is received in opening 1148. The forward end of hydraulic cylinder 136 may be connected to an upper portion 1137b of a bracket 1137 with a spherical bearing connection 1138 (which may be similar to spherical bearing connection 138 described above), that accommodates the lateral pivoting/tilting of main header frame 100. Bracket 1137 also includes a lower portion 1137a, fixedly connected to a mounting cleat 1139, which is in turn fixedly connected to transverse support beam 112a. Upper portion 1137b of bracket 1137 is at a forwards end pivotally connected (via pivotal connection 1145) to lower portion 1137a and at the opposite, rearwards end fixedly connected to the forward end of hydraulic cylinder 136 via spherical bearing connection 1138.

Upper portion 1137b may be pivotally movable (about pivotal connection 1145) relative to lower portion 1137a between a first (fully lowered) position shown in FIG. 7C and a second (fully raised) position shown in FIG. 7D). Upper portion 1137b may be fixed in the first (lowered) position by a locking pin 1153, which is received in axially aligned holes 1147 and 1149 in respective lower portion 1137a and upper portion 1137b of bracket 1137.

Bracket 1137 provides a degree of flexibility to pivotal connection 1403 to assist with connecting swather header 12 to propulsion unit 14. In operation, when connecting swather header 12 to propulsion unit 14, locking pin 1153 may be removed such that upper portion 1137b may be raised or lowered (via pivotal movement relative to lower portion 1137a), such that rear end of upper portion 1137b may be bought into alignment with the forward end of hydraulic cylinder 136 and secured together with locking pin 1151. Once swather header 12 to propulsion unit 14 and interconnected at pivotal connection 1403, locking pin 1153 can be reinserted to fix the position of upper portion 1137b relative to lower portion 1137a.

Swather header 12 and propulsion unit 14 may be connected/disconnected at pivotal connection 1403 either by inserting/removing locking pin 1151 or at pivotal connection 1143 by inserting/removing locking pin 1146.

In other embodiments, upper portion 1137b and hydraulic cylinder 136 may be bought into alignment via retraction/extension of hydraulic cylinder 136, which may be controlled by an operator on propulsion unit 14.

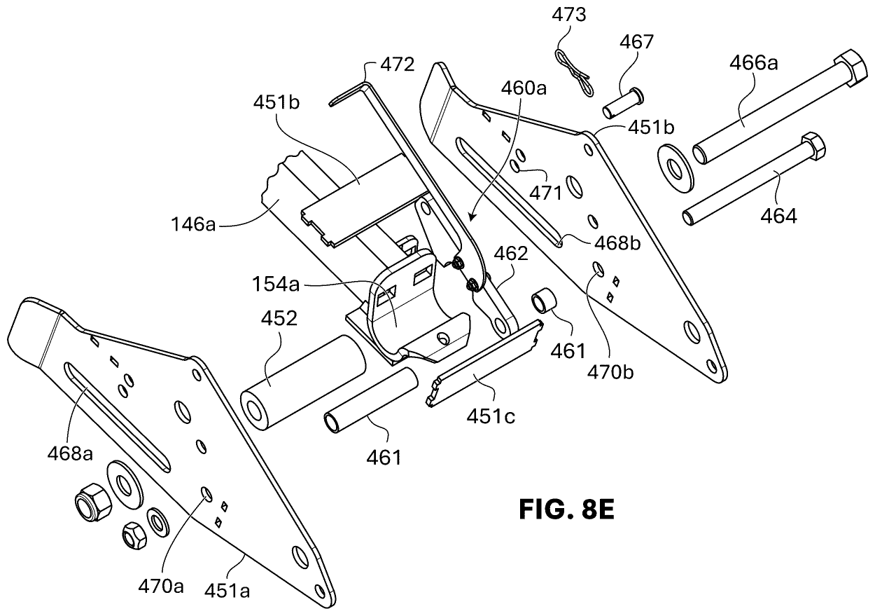

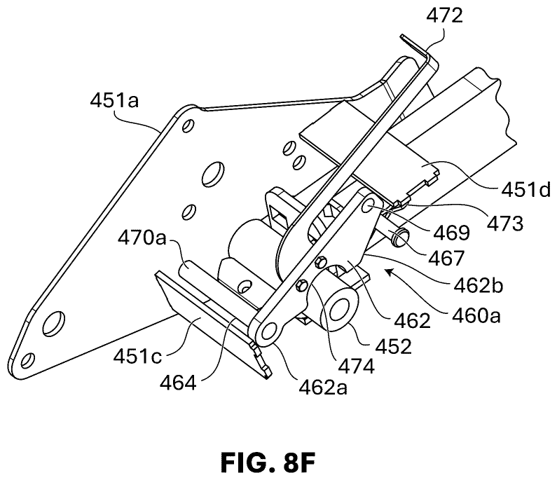

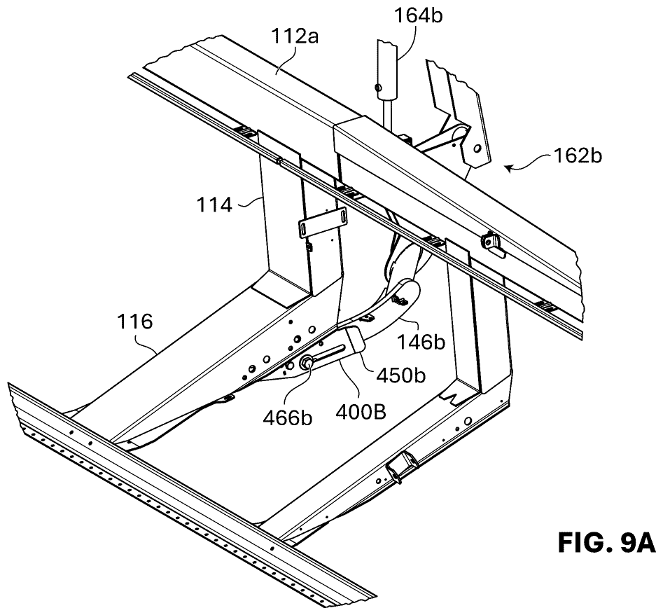

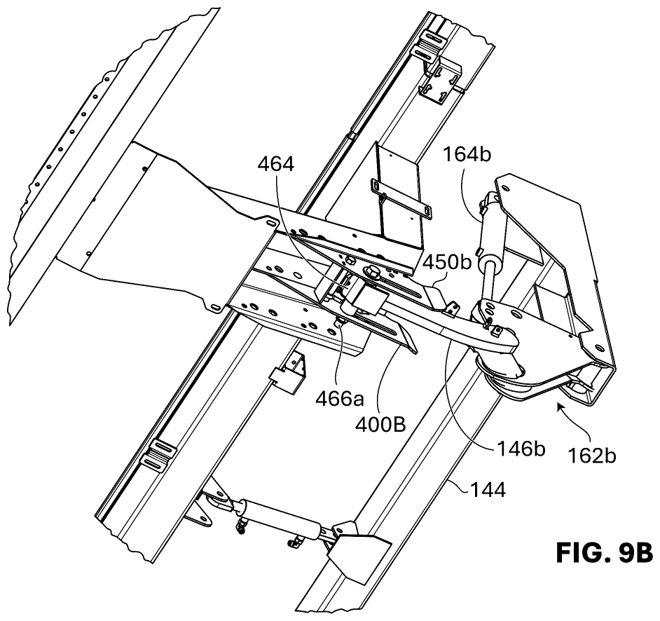

A representative right-side mounting apparatus 400A is illustrated in FIGS. 8A to 8F and a representative left-side mounting apparatus 400B is illustrated in FIGS. 9A to 9D. The associated arrangements of the components of main header frame 100 for right-side mounting apparatus 400A and left-side mounting apparatus 400B may be constructed in the same manner. Accordingly, only right-side mounting apparatus 400A is described herein in detail.

As part of propulsion unit 14, lift arm 146a extends generally/substantially longitudinally forwards from propulsion unit 14, and generally perpendicular to transverse support beam 112a of main header frame 100. The forward distal end portion 152a of lift arm 146a is received within lift boot 450a of mounting apparatus 400A. Lift boot 450a, which may also be known as a lift boot adaptor or lift arm boot adaptor, may extend generally/substantially in a longitudinal direction that is generally orthogonal to the transverse extension of main header frame 100 and is configured to receive, engage and retain the forward end of lift arm 146a, such that lift boot 450a (and components attached thereto) will move with movement of lift arm 146a.

Similarly, as part of propulsion unit 14, lift arm 146b extends generally longitudinally forwards from propulsion unit 14, and generally perpendicular to transverse support beam 112a of main header frame 100. The forward distal end portion 152b of lift arm 146b is received within lift boot 450b of mounting apparatus 400B. Lift boot 450b, which may also be known as a lift boot adaptor or lift arm boot adaptor, is configured to receive, engage and retain the forward end of lift arm 146b, such that lift boot 450b (and components attached thereto) will move with movement of lift arm 146b.

Lift boots 450a and 450b, acting as extensions of the power unit lift arms 146a, 146b may carry the majority of the un-sprung load/mass of swather header 12 to the supporting body of the propulsion unit 14 (minus load/mass carried by any ground engaging header elements of header 12, such as cutterbar 122 and/or stabilizer apparatus(es) 500, for example gauge wheels). The upper pivotal connection 403 will typically carry no downward/upwardly directed loads and generally act as position locators only.

Lift boot 450a may be made from any suitably strong and appropriately configurable material, such as a hardened steel, such as ASTM A36 steel.

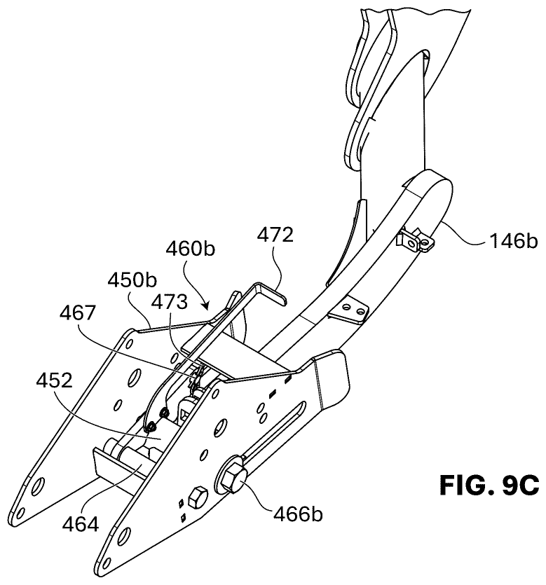

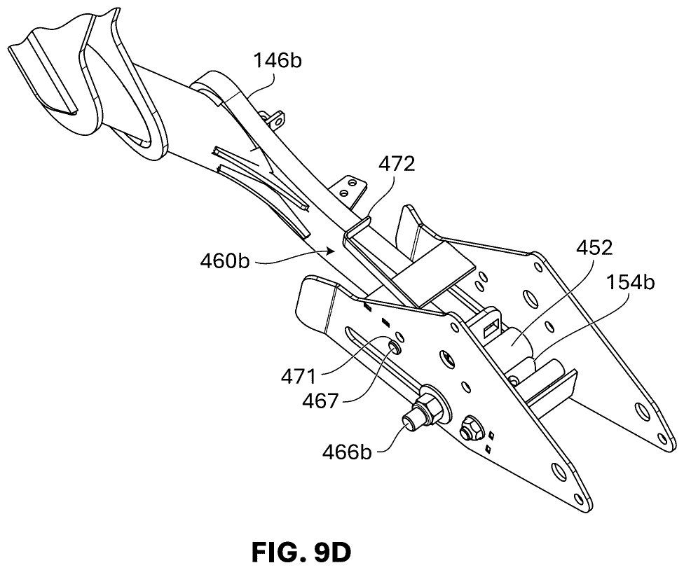

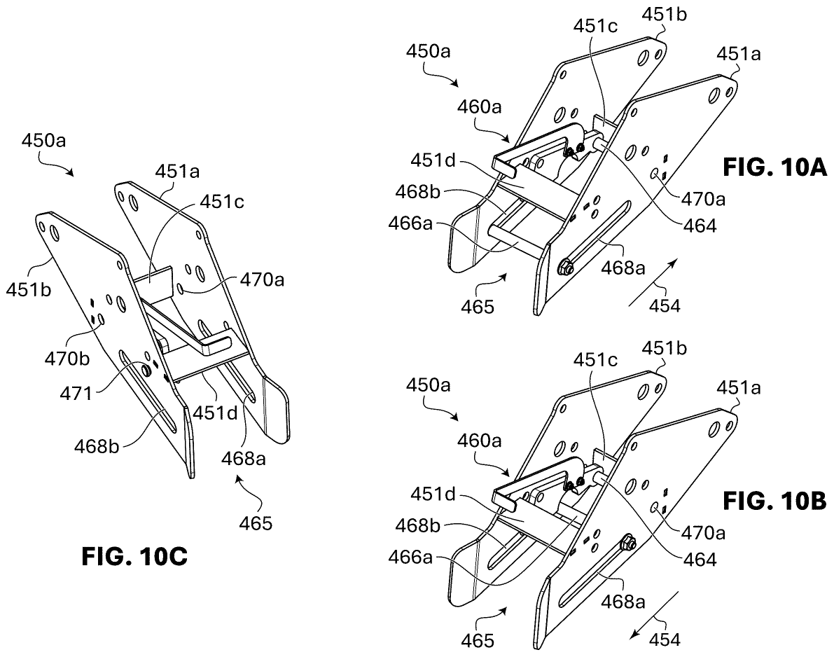

Lift boot 450a is shown in isolation in FIGS. 10A-C and includes a pair of transversely spaced, generally parallel orientated in relation to each other and forwardly directed, vertically and longitudinally extending support members 451a, 451b; generally rectangular, generally transversely and longitudinally extending support plates 451c and 451d that are fixedly connected to support members 451a, 451b. Support members 451a, 451b and support plates 451c, 451d define an opening 465 to slidingly receive the forward end of lift arm 146a therewithin. The ends of support plates 451c, 451d may be flanged outwards to assist in receiving/locating the forward end of lift arm 146a within lift boot 450a. Support members 451a, 451b and support plates 451c, 451d may form part of an integral weldment and may be formed from the same suitably strong material.

Lift boot 450b is shown in FIGS. 9A to 9D as part of right-side mounting apparatus 400B and may be constructed in similar manner and from similar materials to lift boot 450a, but may be constructed as a substantially the mirror of lift boot 450a.

As explained earlier, a plurality of transversely spaced, generally downwardly depending, vertical struts 114 may be fixedly secured to transverse support beam 112 and a bottom end region of each vertical strut 114 may be a generally forwardly extending horizontal strut 116 to which lift boot 450a may be fixedly attached, such as by welding or bolting (FIG. 8C). Each horizonal strut 116 may include strut members 116a, 116b and lift boot 450a may be fixedly attached to either or both of strut members 116a, 116b. In the embodiment shown in FIG. 8C, the outer face of longitudinally extending support member 451a of lift boot 450a is attached to the inner face of strut member 116a of lift boot 450a. The attachment point of lift boot 450a may place transverse axis X1 (FIGS. 7A and 8C) described above at or close to the fore/aft center of gravity of swather header 12. This may ensure that swather header 12 has acceptable “pitch stability”, such that swather header 12 does not pitch forwards (pivoting about moveable members 466a, 466b) when swather header 12 is lifted. The pitch stability of swather header 12 may beneficially maintain substantially a constant load (i.e., “load stability”) on hydraulic cylinder 136 of upper pivotal connections 403/1403 (FIGS. 7B-D).

Support members 451a, 451b each include a longitudinally extending slots 468a, 468b respectively, configured to receive opposed ends of a moveable member 466a therethrough (FIG. 10A). Moveable member 466a is also received and is pivotably movable within a bushing 452 (FIG. 8C) which is in turn sandwiched between the inner faces of support members 451a, 451b. Moveable member 466a may be, for example, a pin sized to be slidably moveable in slots 468a, 468b in the direction indicated by arrow 454 (generally towards a front end of implement 100) from a first position shown in FIG. 10A to a second position shown in FIG. 10B. Moveable member 466a (along with bushing 452) may also be moveable in the direction indicated by arrow 454 in FIG. 10B between the second position shown in FIG. 10B and the first position shown in FIG. 10B.

In an embodiment disclosed, slots 468a, 468b are sloped downward toward the first position, such that gravity tends to pull the moveable member 466a into the first position when not locked in the second position.

In some embodiments, moveable member 466a may be biased into the first position (when not locked in the second position) by any suitable means, for example a spring.

Similarly with reference to FIGS. 9A-D, mounting apparatus 400B may include a moveable member 466b (which is also received and is pivotally mountable within a bushing 452), movable between a first position to a second position.

Moveable members 466a, 466b may be made from any suitably strong and configured material, such as hardened steel (such as ASTM A36 steel).

Mounting apparatuses 400A and 400B may each include respective primary locking mechanisms 460a, 460b each configured to retain the respective moveable members 466a, 466b (along with their bushings 452) in their second positions. Primary locking mechanisms 460a, 460b may be moveable between a first position (shown in FIGS. 8D-F with respect to primary locking mechanism 460a and mounting apparatus 400A) and a second position (shown in FIGS. 9C and 9D with respect to primary locking mechanism 460b and mounting apparatus 400B).

With reference to FIGS. 8D-F in particular, primary locking mechanism 460a includes a retainer member 462 extending in a rearward direction. Retainer member 462 may be pivotally mounted at a forward end 462a by a transversely extending pin 464 that extends between opposed openings 470a, 470b in support members 451a, 451b (FIGS. 10A and 10C). Pin 464 is also received within bushing 461 that is sandwiched between the inner faces of support members 451a, 451b. Retainer member 462a may be moved from a first position (shown in FIGS. 8D and 8F with respect to primary locking mechanism 460a) to a second position (such as shown in FIGS. 9C and 9D with respect to primary locking mechanism 460b). As retainer member 462 is moved to the second position, bushing 452 is received in and is engaged by a generally semi-circular cutout portion 474 of retainer member 462, thereby preventing movement of bushing 452 and moveable member 466a therewithin, such that movable member 466a is unable to move within the opposed channels 468a, 468b of lift boot 450a, thereby establishing a locked configuration of movable member 466a.

Primary locking mechanism 460a may be retained in the first position when pin 467 is inserted through opening 471 of support member 451a but not opening 469 of retainer member 462, for example under and supporting retainer member 462 (as shown in FIG. 8F). In this configuration, gravity holds retainer member 462 against pin 467, which prevents retainer member 462 from dropping down into the second position.

Primary locking mechanism 460a may be retained in the second position by a locking pin such as clevis pin 467 (FIG. 8F) which extends through an opening 469 in retainer member 462 and an opening 471 in support member 451b of lift boot 450a (FIG. 8E, FIG. 10C). Clevis pin 467 is releasably secured in place, for example by a cotter pin 473.

Similarly, primary locking mechanism 460b may be retained in the second position by pin 467 (FIGS. 9C and 9D).

When primary locking mechanism 460a is in the first position (FIGS. 8D and 8F), moveable member 466a is free to move within opposed channels 468a, 468b of lift boot 450a. When the primary locking mechanism 460a is in the second position, moveable member 466a is not able to move relative to lift boot 450a and is therefore not able to move within opposed channels 468a, 468b, thereby establishing the locked configuration of movable member 466a.

Similarly, when the primary locking mechanism 460b is in the first position, moveable member 466a is free to move within opposed channels 468b, 468b of lift boot 450b. When the primary locking mechanism 460b is in the second position (FIGS. 9C and 9D), moveable member 466b is not able to move relative to lift boot 450b and is therefore not able to move within opposed channels 468a, 468b, thereby establishing the locked configuration of movable member 466b.

When locked in the second position, lift boot 450a, 450b and thus swather header 12 may pivot, as permitted by propulsion unit 14, about moveable members 466a, 466b on lift arms 146a, 146b.

In other embodiments, primary locking mechanism 460 may be any suitable mechanism, for example a latch mechanism, operable to retain movable member 466a in the second position.

As explained above, opening 465 of lift boot 450a is sized to receive the forward end of lift arm 146a and moveable member 466a is received in moveable member receiving channel 154a (FIG. 6C), such that a lower portion of moveable member 466a is cradled by moveable member receiving channel 154a.

Moveable member 466a and bushing 452 may be secured in moveable member receiving channel 154a by a secondary locking mechanism such as secondary locking mechanism 476 shown in FIG. 6C. Secondary locking mechanism 476 may include a sliding bar 156 that includes two forwardly extending and spaced apart rods 158a and 158b which are interconnected at their rear ends by a connecting portion 160. The forward ends of rods 158a and 158b are received in respective openings 159a and 159b in lower end portion 152a of lift arm 146a. Sliding bar 156 is slidably moveable in directions 161a and 161b (FIG. 6C). When bushing 452 (which has moveable member 466a therewithin) is received in moveable member receiving channel 154a, sliding bar 156 may be moved in direction 161a such that the forwards ends of rods 158a and 158b fit around the upper portion of bushing 452 and on the opposite side to moveable member receiving channel 154a, such that bushing 452 and moveable member 466a are retained by the combination of moveable member receiving channel 154a and sliding bar 156. Thus, the lift arm 146a is secured to bushing 452 and moveable member 466a and will move with bushing 452 and moveable member 466a until the secondary locking mechanism 474 is removed/released.

The diameter of bushing 452 is selected based on the size of receiving channel 154a and may be selected to allow mounting apparatus 400A to connect with different configurations of lift arms (e.g., lift arms with different sized receiving channels).

With reference to FIG. 6D, another embodiment of a secondary locking mechanism, secondary locking mechanism 576, is depicted in relation to lift arm 146b. Secondary locking mechanism 576 may include a sliding bar 556 that includes a single forwardly extending rod 558a (which may be generally similar to rod 158a described above), the forward end of which is received in opening 159a in lower end portion 152b of lift arm 146b. Rod 558a is slidably moveable in directions 561a and 561b (FIG. 6D) through operation of lever 580. When bushing 452 (which has moveable member 466a therewithin) is received in moveable member receiving channel 154b, sliding bar 556 may be moved in direction 161a such that the forwards end of rod 158a fit around the upper portion of bushing 452 and on the opposite side to moveable member receiving channel 154b, such that bushing 452 and moveable member 466a is retained by the combination of moveable member receiving channel 154b and sliding bar 556. Thus, the lift arm 146a is secured to moveable member 466a and will move with moveable member 466a until the secondary locking mechanism 474 is removed/released.

In some embodiments, secondary locking mechanism 576 may be configured in substantially the mirror of as shown in FIG. 6D, whereby rod 558a of sliding bar 556 of is received in opening 159b.

In other embodiments, the secondary locking mechanism 476 may, additionally or alternately include one or more transversely extending pins that are inserted thorough both of support members 451a, 451b proximal to (e.g., above or below) lower end portion 152a of moveable member receiving channel 154a to secure lift arm 146a in place relative to lift boot 450a.

In other embodiments, secondary locking mechanism 476 may be any suitable mechanism operable to secure lift arm 146a to bushing 452 and movable member 466a. For example, secondary locking mechanism 476 may be a mechanism generally similar to primary locking mechanisms 460a, 460b described above and may include a retainer member, similar to retainer member 462 described above, configured to engage and retain movable member 466a in moveable member receiving channel 154b.

Similarly, opening 465 of lift boot 450b is sized to receive the forward end of lift arm 146b and bushing 452 and moveable member 466b are received in moveable member receiving channel 154b of lift arm 146b and is secured by a secondary locking mechanism such as secondary locking mechanism 476.

In some embodiments, primary locking mechanisms 460a, 460b and secondary locking mechanisms 476 or 578 may be combined into a single locking mechanism operably connected to either of lift boot 450a and lift arm 146a and operable to both secure lift arm 146a to moveable member 466a and to also retain and the moveable member 446 in the second position.

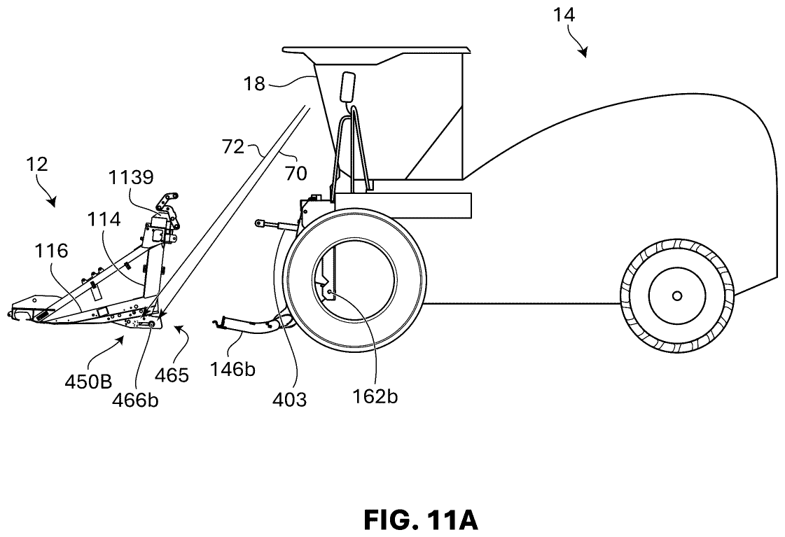

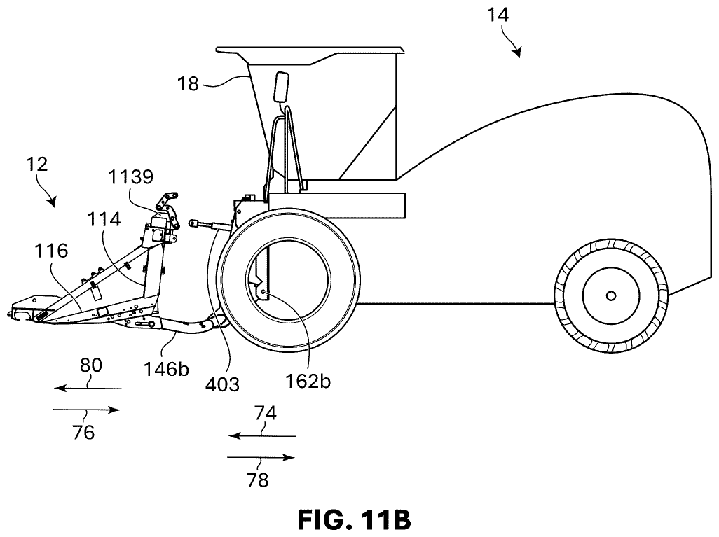

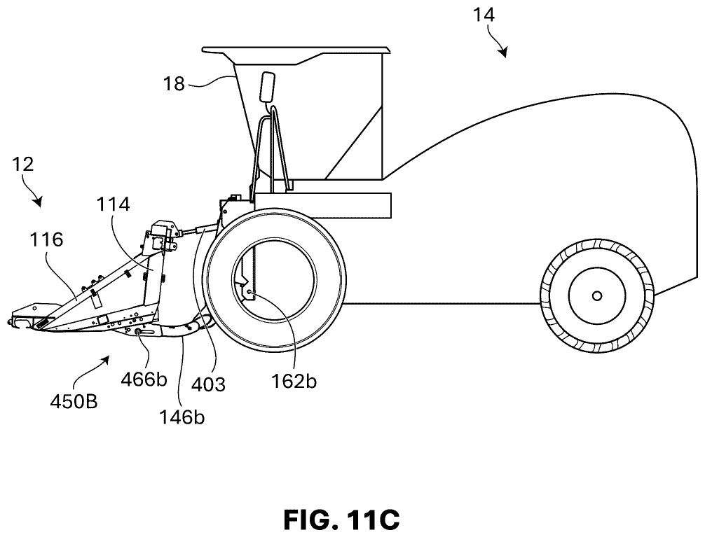

With reference to FIGS. 11a-c, the connection between propulsion unit 14 and swather header 12 will now be described.

With reference to FIG. 11A, propulsion unit 14 and swather header 12 are shown prior to connection. Swather header 12 may be resting on the ground surface or may supported, for example in a stand/mount (not shown in FIG. 11A). Moveable members 466a, 466b may be in the second position, for example from last use. If so, moveable members 466a, 466b may be unlocked and move or be moved into the first position. Moveable members 466a, 466b may be in the first position (466b shown in solid lines in FIG. 11A) and propulsion unit 14 may be in a mounting ready configuration, whereby lift arms 146a and 146b are positioned such that the lower end portions 152a, 152b of lift arms 146a, 146b are vertically and horizontally aligned with the openings 465 of mounting apparatuses 400A, 400B. As shown in FIG. 11A, when propulsion unit 14 is in the mounting ready configuration, the first position of moveable members 466a, 466b is proximal to propulsion unit 14 and the second position of moveable members 466a, 466b is distal to prolusion unit 14. An operator may control the vertical alignment of lower end portions 152a, 152b relative to openings 465 by operation of hydraulic cylinders 164a, 164b as described above. An operator may control the lateral alignment of lower end portions 152a, 152b relative to openings 465 by operation of the drive system propulsion unit 14. The lateral alignment may involve physical lateral alignment of the propulsion unit itself, as the lift arms 146a, 146b may not provide lateral movement (see e.g. FIG. 6B).

As will be apparent from FIG. 11A, an operator in the cab 18 of propulsion unit 14 will have a clear line of sight (represented by arrow 70 in FIG. 11A) of moveable members 466a, 466b when moveable members 466a, 466b are in their first positions. This will beneficially allow the operator to align moveable member receiving channels 154a, 154b relative to the moveable members 466a, 466b of mounting apparatuses 400A, 400B whilst the operator is in cab 18 when making a connection between propulsion unit 14 and swather header 12. It is relatively common and necessary to disconnect propulsion unit 14 and swather header 12 from time to time, for example to facilitate road transport of swather header 12, maintenance, off-season storage, etc. Therefore it is relatively common and necessary to re-connect propulsion unit 14 and swather header 12.

Conversely, if moveable members 466a, 466b are in their second positions, which may be necessary when swather header is in an operating position, an operator would not have a clear line of sight (represented by arrow 72 in FIG. 11A) of the moveable members 466a, 466b, presenting a challenge when attempting to align moveable member receiving channels 154a, 154b with each of the moveable members 466a, 466b of mounting apparatuses 400A, 400B.

By allowing the operator to have clear light of sight of moveable members 466a, 466b when connecting propulsion unit 14 to swather header 12, the process of connection may be safer, faster, require less people and the risk of damage to components propulsion unit 14 or swather header 12 caused by collisions may be beneficially reduced.

Once the moveable member receiving channels 154a, 154b are positioned directly below the moveable members 466a, 466b, lift arms 146a and 146b may be raised in an upwards direction relative to swather header 12 (by operation of hydraulic cylinders 164a, 164b as described above) such that the moveable members 466a, 466b (and their bushings 452) of mounting apparatuses 400A, 400B are received the respective moveable member receiving channels 154a, 154b, thereby establishing a mounted configuration of swather header 12 and propulsion unit 14.

In some embodiments, instead of or in addition to raising lift arms 146a and 146b, swather header 12 may be lowered relative to propulsion unit 14 such that the moveable members 466a, 466b of mounting apparatuses 400A, 400B are received the respective moveable member receiving channels 154a, 154b.

Turning to FIG. 11B, once the moveable members 466a, 466b of mounting apparatuses 400A, 400B are received the respective moveable member receiving channels 154a, 154b (thereby interconnecting lift arms 146a and 146b and swather header 12) propulsion unit 14 may be advanced forward in direction 74 relative to swather header 12, thereby moving movable members 466a, 466b from the first position shown in FIG. 11B to the second position shown in FIG. 11C.

As, the movable members 466a, 466b move from the first position to the second position, (sliding in the slots 468a, 468b) the members will engage and the ramped face 462b (FIG. 8F) of retainer member 462, pushing retainer member upwards as movable members 466a, 466b slide towards the second position. Once movable members 466a, 466b are in the second position, pin 467 may be removed and retainer member 462 will fall back down due to gravity and cutout portion 474 will engage the respective movable member 466a, 466b. An operator, for example in the cab 18 of propulsion unit 14, can verify when the movable members 466a, 466b are in the second position (and the respective retainer members 462 are also in their second positions) because as retainer member 462 moves upwards, the end of arm 472 (which is visible to an operator in cab 18) will rise and then drop once retainer member 462 is in the second position. Retainer member 462 is then releasably secured by clevis pin 467 and cotter pin 473 as described above.

In other embodiments, an operator may lift up retainer member 462 (such as by lifting arm 472) such that the movable members 466a, 466b may slide past to their second positions. Once in their second positions, retainer member 462 is then releasably secured by clevis pin 467 and cotter pin 473 as described above. An operator may move retainer member 462 if needed to help align the holes for clevis pin 467 such as by movement of arm 472.

In some embodiments, instead of or in addition to advancing propulsion unit 14 in direction 74, swather header may be advanced in direction 76 relative to propulsion unit 12 thereby moving movable members 466a, 466b from the first position shown in FIG. 11B to the second position shown in FIG. 11C.

Once movable members 466a, 466b are in their second positions shown in FIG. 11C, they may then be retained in the moveable member receiving channels 154a, 154b as described above (for example by secondary locking mechanism 476 described above or secondary locking mechanism 556 described below or otherwise retained) such that the lift arms 146a and 146b are interconnected to swather header 12.

Before or after retaining movable members 466a, 466b in the moveable member receiving channels 154a, 154b they may also be retained in their second positions for example by their respective primary locking mechanisms 460a, 460b as described above, thereby establishing a locked configuration of movable members 466a, 466b in the second position.

As explained above, upper connecting apparatus 403 or 1403 provides a connection between transverse beam member 144 of propulsion unit 14 and transverse support beam 112a of main header frame 100. This connection may be made once movable members 466a, 466b are in their second positions, either prior to or after establishing the locked configuration of movable members 466a, 466b.

In embodiments where the connection between transverse beam member 144 of propulsion unit 14 and transverse support beam 112a of main header frame 100 is made using upper connecting apparatus 1403, once hydraulic cylinder 136 has been connected and upper portion 1137b of bracket 1137 is in the second (raised) position shown in FIG. 7D, the operator may control the operation of hydraulic cylinder 136 to move upper portion 1137b (about pivot connection 1145) relative to lower portion 1137a to the first (lowered) position shown in FIG. 7C. When holes 1147 and 1149 are aligned, locking pin 1153 may then be inserted through axially aligned holes 1147 and 1149 to fix the position of upper portion 1137b relative to lower portion 1137a. Operation of hydraulic cylinder 136 is then operable to tilt header 12 through bracket 1137.

In some embodiments, transverse beam member 144 of propulsion unit 14 and transverse support beam 112a of main header frame 100 may be connected by upper connecting apparatus 403 whilst movable members 466a, 466b are in the first position (i.e., as shown in FIG. 11B).

The disconnection between propulsion unit 14 and swather header 12 may be substantially the reverse of as described above, whereby the primary locking mechanism 460 is released, prior to movement of moveable members 466a, 466b to their first positions (either by advancing propulsion unit 14 in direction 78 or swather header in direction 80 (as shown in FIG. 11B).

The moveable members 466a, 466b may then be released from the moveable member receiving channels 154a, 154b by releasing secondary locking mechanism 476 such that the lift arms 146a and 146b are disconnected from swather header 12.

Prior to, or after these steps transverse beam member 144 of propulsion unit 14 and transverse support beam 112a of main header frame 100 may be disconnected upper by disconnecting apparatus 403, such as by disconnecting hydraulic cylinder 136 at either end.

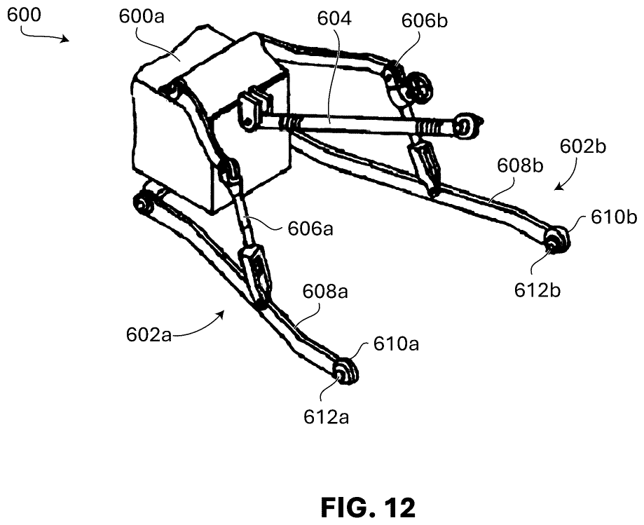

In other embodiments, lift boots 450a, 450a of mounting apparatuses 400A, 400B respectively may be able to accommodate/connect to other types/configurations of lift arms, depending on the type of propulsion unit being used. For example, the lift arms may include, rather than moveable member receiving channels 154a, 154b, transversely extending holes at the lower distal end region/portion 152a, 152b through which moveable members 466a, 446b may be received. An example of this configuration will be described below with respect to FIG. 12.

In various embodiments, the propulsion unit may be any propulsion unit, such as a tractor with a multi-point hitch, such as a three-point hitch (which may at the front or rear of the propulsion unit, to which an implement is mounted). In an embodiment, the propulsion unit is a tractor with a standard type of rearward three-point hitch. A representative example of a three-point hitch 600 is depicted in FIG. 12, which may be connected at a rear end 600a to the front or rear end of a propulsion unit. Three-point hitch 600 may include a pair of transversely spaced lower powered (at least upwardly powered) lift arms 602a, 602b and an upper center arm 604 (top link) that may or may not be powered. Lift arms 602a, 602b may be generally similar to lift arms 146a, 146b and include generally forwardly extending members 608a, 608b which terminate at lower end portions 610a, 610b. Respective openings 612a, 612b, extend transversely through lower end portions 610a, 610b. Each arm 602a, 602b may include leveling assembly 606a, 606b respectively, configured to allow adjustment of the height of lift arms 602a, 602b. The three-point hitch 600 may also include one or more stabilizer arms/links to reduce lateral side to side sway movement of the implement when attached to the three-point hitch. Thus, an agricultural implement, such as swather header 12 can be connected to a propulsion unit by an embodiment of the three-point pivotal connection (including right-side mounting apparatus 400A, left-side mounting apparatus 400B and upper pivotal connection 403) as described herein. In such embodiments, a moveable members 466a, 466b may be received in each of openings 612a, 612b, in lower end portions 610a, 610b of lift arms 602a, 602b and secured as described above. The rearward three-point hitch may be more applicable to rearward mounted implements, such as ground engaging implements, cultivators, mowers, seeders, etc. where an operator seated (not shown) near rear end 600 and facing or turned to face lower end portions 610a, 610b can align openings 612a, 612b of mating movable members associated with the implement being connected similar to that as described above with regard to swather header 12.

In embodiments where the lift arms are configured in a different manner to lift arms 146a, 146b, for example lift arms 602a, 602b (with respective openings 612a, 612b therethrough) and adaptor may be secured to the lower end portions of the lift arms to facilitate connection to lift boots 450a, 450a. The adaptor may have a first end configured to be secured to the lower end portion of the lift arm and a second end that includes a receiving channel. The receiving channel may be configured in a similar to receiving channels 154a, 154b described above for receiving a moveable member, such as moveable members 466a, 466b described above.

As an aside, the transverse positioning of the lift arms 146a, 146b and corresponding mounting apparatuses 400a, 400b, can be selected to provide for relatively balanced side to side loads acting on lift arms 146a, 146b.

When introducing elements of the present invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

The term “comprise,” including any variation thereof, is intended to be open-ended and means “include, but not limited to,” unless otherwise specifically indicated to the contrary.

When a set of possibilities or list of items is given herein with an “or” before the last item, any one of the listed items or any suitable combination of two or more of the listed items may be selected and used.

The above-described embodiments are intended to be illustrative only. Modifications are possible, such as modifications of form, arrangement of parts, details and order of operation. The examples detailed herein are not intended to be limiting of the invention. Rather, the invention is defined by the claims.

1. An agricultural apparatus comprising:
a propulsion unit comprising at least one, elongated and generally longitudinally extending, lift arm;
a generally transversely extending implement;
at least one mounting apparatus operably connected with the implement, the at least one mounting apparatus comprising a moveable member configured to interconnect the at least one lift arm and the implement;
wherein the movable member is movable relative to the implement between a first position proximal to the propulsion unit when the propulsion unit is in a mounting ready configuration and a second position distal to the propulsion unit when the propulsion unit is in a mounting ready configuration; and
wherein the moveable member is retainable in the second position.

2. The agricultural apparatus of claim 1, wherein the at least one mounting apparatus is operably located between the at least one lift arm and the implement.

3. The agricultural apparatus of claim wherein the implement comprises a generally transversely extending main frame.

4. The agricultural apparatus of claim 3, wherein the at least one mounting apparatus is operable to releasably interconnect the main frame and the implement.

5. The agricultural apparatus of claim 1, wherein the at least one mounting apparatus further comprises a primary locking mechanism operable to releasably retain the moveable member in the second position.

6. The agricultural apparatus of claim 1, wherein the first position of the moveable member is proximal to a distal end region of the at least one lift arm when the propulsion unit is in a mounting ready configuration.

7. The agricultural apparatus of claim 6, wherein the distal end region of the at least one lift arm includes a receiver configured to engage the movable member when the moveable member is in the first position and the propulsion unit is in the mounting ready configuration to establish a mounted configuration of the propulsion unit and the implement.

8. The agricultural apparatus of claim 7, wherein the agricultural apparatus further comprises a secondary locking mechanism operable to releasably retain the moveable member in the receiver.

9. The agricultural apparatus of claim 1, wherein the at least one mounting apparatus further comprises a first member, wherein the at least one lift arm and the first member extend generally in a longitudinal direction that is generally orthogonal to the transverse extension of the implement.

10. The agricultural apparatus of claim 9, wherein the first member receives at least a portion of the at least one lift arm.

11. The agricultural apparatus of claim 9, wherein the moveable member extends in a longitudinal direction that is generally orthogonal to the longitudinal extension of the at least one lift arm and the first member, and the moveable member is slidably moveable relative to the first member between the first position and the second position.

12. The agricultural apparatus of claim 1, wherein the at least one lift arm comprises a first lift arm, and wherein the at least one lift arm further comprises a second elongated, generally longitudinally extending second lift arm, the first lift arm being transversely spaced from the second lift arm, the second lift arm having an end region and being transversely spaced from the first lift arm;
and wherein the at least one mounting apparatus comprises a first mounting apparatus comprising a first moveable member configured to interconnect the first lift arm and the implement, and wherein the at least one mounting apparatus further comprises a second mounting apparatus comprising a second moveable member configured to interconnect the second lift arm and the implement.

13. The agricultural apparatus of claim 12, wherein the first and second mounting apparatuses provide first and second lower operational connections between the implement and the first and second lift arms respectively, and wherein the agricultural apparatus further comprises an upper connection apparatus operationally connecting the propulsion unit and the implement at a third operational connection above the first and second operational connections.

14. The agricultural apparatus of claim 13, wherein the upper connection apparatus and the mounting apparatuses are configured in a generally triangular shaped three-point arrangement.

15. The agricultural apparatus of claim 1, wherein the implement is a swather header.

16. The agricultural apparatus of claim 1, wherein the propulsion unit is a tractor, and wherein said at least one lift arm comprises part of a three-point hitch of said tractor.

17. A mounting apparatus for interconnecting a propulsion unit and an implement, the mounting apparatus comprising:
a moveable member configured to interconnect at least one, elongated and generally longitudinally extending lift arm of the propulsion unit and the implement;
wherein the movable member is movable relative to the implement between a first position proximal to the propulsion unit when the propulsion unit is in a mounting ready configuration and a second position distal to the propulsion unit when the propulsion unit is in a mounting ready configuration; and
wherein the moveable member is retainable in the second position.

18. The mounting apparatus of claim 17, wherein the at least one mounting apparatus is operably located between the at least one lift arm and the implement.

19. The agricultural apparatus of claim 17, wherein the implement comprises a generally transversely extending main frame.

20. The mounting apparatus of claim 19, wherein the at least one mounting apparatus is operable to releasably interconnect the at least one lift arm and the main frame.

21. The mounting apparatus of claim 17, wherein the at least one mounting apparatus further comprises a primary locking mechanism operable to releasably retain the moveable member in the second position.

22. The mounting apparatus of claim 17, wherein the first position of the moveable member is proximal to a distal end region of the at least one lift arm when the propulsion unit is in a mounting ready configuration.

23. The mounting apparatus of claim 22, wherein the distal end region of the at least one lift arm includes a receiver configured to engage the movable member when the moveable member is in the first position and the propulsion unit is in a mounting ready configuration to establish a mounted configuration of the propulsion unit and the implement.

24. The mounting apparatus of claim 23, wherein the at least one mounting apparatus further comprises a secondary locking mechanism operable to releasably retain the moveable member in the receiver.

25. The mounting apparatus of claim 17, wherein the at least one mounting apparatus further comprises a first member, wherein the at least one lift arm and the first member extend generally in a longitudinal direction that is generally orthogonal to the transverse extension of the implement.

26. The mounting apparatus of claim 25, wherein the first member receives at least a portion of the at least one lift arm.

27. The mounting apparatus of claim 25, wherein the moveable member extends is a longitudinal direction that is generally orthogonal to the longitudinal extension of the at least one lift arm and the first member and the moveable member is slidably moveable relative to the first member from the first position to the second position.

28. The mounting apparatus of claim 17, wherein the at least one lift arm comprises a first lift arm, and wherein the at least one lift arm further comprises a second elongated, generally longitudinally extending second lift arm, the first lift arm being transversely spaced from the second lift arm, the second lift arm having an end region and being transversely spaced from the first lift arm;
and wherein the at least one mounting apparatus comprises a first mounting apparatus comprising a first moveable member configured to interconnect the first lift arm and the implement, and wherein the at least one mounting apparatus further comprises a second mounting apparatus comprising a second moveable member configured to interconnect the second lift arm and the implement.

29. The mounting apparatus of claim 28, wherein the first and second mounting apparatuses provide first and second lower operational connections between the implement and the first and second lift arms respectively, and wherein the agricultural apparatus further comprises an upper connection apparatus operationally connecting the propulsion unit and the implement at a third operational connection above the first and second operational connections.

30. The mounting apparatus of claim 29, wherein the upper connection apparatus and the mounting apparatuses are configured in a generally triangular shaped three-point arrangement.

31. The mounting apparatus of claim 17, wherein the implement is a swather header.

32. The mounting apparatus of claim 17, wherein the propulsion unit is a tractor, and wherein said at least one lift arm comprises part of a three-point hitch of said tractor.

33. An agricultural implement comprising:
at least one mounting apparatus operably connected with the implement comprising a moveable member configured to interconnect the implement and at least one, elongated and generally longitudinally extending, lift arm of a propulsion unit;
wherein the movable member is movable relative to the implement between a first position proximal to the propulsion unit when the propulsion unit is in a mounting ready configuration and a second position distal to the propulsion unit when the propulsion unit is in a mounting ready configuration; and
wherein the moveable member is retainable in the second position.

34. The agricultural implement of claim 33, wherein the at least one mounting apparatus is operably located between the at least one lift arm and the implement.

35. The agricultural apparatus of claim 33, wherein the implement comprises a generally transversely extending main frame.

36. The agricultural implement of claim 35, wherein the at least one mounting apparatus is operable to releasably interconnect the at least one lift arm and the main frame.

37. The agricultural implement of claim 33, wherein the at least one mounting apparatus further comprises a primary locking mechanism operable to releasably retain the moveable member in the second position.

38. The agricultural implement of claim 33, wherein the first position of the moveable member is proximal to a distal end region of the at least one lift arm when the propulsion unit is in a mounting ready configuration.

39. The agricultural implement of claim 38, wherein the distal end region of the at least one lift arm includes a receiver configured to engage the movable member when the moveable member is in the first position and the propulsion unit is in a mounting ready configuration to establish a mounted configuration of the propulsion unit and the implement.

40. The agricultural implement of claim 39, wherein the at least one mounting apparatus further comprises a secondary locking mechanism operable to releasably retain the moveable member in the receiver.

41. The agricultural implement of claim 33, wherein the at least one mounting apparatus further comprises a first member, wherein the at least one lift arm and the first member extend generally in a longitudinal direction that is generally orthogonal to the transverse extension of the implement.

42. The agricultural implement of claim 41, wherein the first member receives at least a portion of the at least one lift arm.

43. The agricultural implement of claim 4, wherein the moveable member extends is a longitudinal direction that is generally orthogonal to the longitudinal extension of the at least one lift arm and the first member and the moveable member is slidably moveable relative to the first member from the first position to the second position.

44. The agricultural implement of claim 33, wherein the at least one lift arm comprises a first lift arm, and wherein the at least one lift arm further comprises a second elongated, generally longitudinally extending second lift arm, the first lift arm being transversely spaced from the second lift arm, the second lift arm having an end region and being transversely spaced from the first lift arm;
and wherein the at least one mounting apparatus comprises a first connection apparatus comprising a first moveable member configured to interconnect the first lift arm and the implement, and wherein the at least one mounting apparatus further comprises a second mounting apparatus comprising a second moveable member configured to interconnect the second lift arm and the implement.

45. The agricultural implement of claim 44, wherein the first and second mounting apparatuses provide first and second lower operational connections between the implement and the first and second lift arms respectively, and wherein the agricultural apparatus further comprises an upper connection apparatus operationally connecting the propulsion unit and the implement at a third operational connection above the first and second operational connections.

46. The agricultural implement of claim 45, wherein the upper connection apparatus and the mounting apparatuses are configured in a generally triangular shaped three-point arrangement.

47. The agricultural implement of claim 33, wherein the implement is a swather header.

48. The agricultural implement of claim 33, wherein the propulsion unit is a tractor, and wherein said at least one lift arm comprises part of a three-point hitch of said tractor.
